(19) United States
(12) Patent Application Publication
(10) Pub. No.: US 2022/0264283 A1
(43) Pub. Date: Aug. 18, 2022

(54) METHOD, APPARATUS, AND COMPUTER PROGRAM PRODUCT TO FACILITATE CONTROL OF TERMINAL TIMING INFORMATION WITHIN A NETWORK

(71) Applicant: NOKIA TECHNOLOGIES OY, Espoo (FI)

(72) Inventor: Sung Hwan WON, Flower Mound, TX (US)

(73) Assignee: NOKIA TECHNOLOGIES OY, Espoo (FI)

(21) Appl. No.: 17/669,213

(22) Filed: Feb. 10, 2022

Related U.S. Application Data
(60) Provisional application No. 63/149,540, filed on Feb. 15, 2021.

(51) Int. Cl. H04W 8/06; H04W 76/25

(52) U.S. Cl. CPC H04W 8/06; H04W 84/042; H04W 76/25

(57) ABSTRACT

Methods, apparatuses, and computer program products are provided to facilitate identification of user equipment that supports connected mode control information for controlling a time to stay in a public land mobile network. Determinations of whether a user equipment supports connected mode control information may be received by a unified data management function via a unified data repository, or a steering of roaming application function, that may be configured with a permanent equipment identifier database. User equipment that supports connected mode control information may cause transmission, via a visited public land mobile network, of an indication that the user equipment supports connected mode control information to a unified data management function associated with a home public land mobile network. An indication that the user equipment supports connected mode control information may be transmitted via a steering of roaming transparent container configured as a secured container.

### CROSS REFERENCE TO RELATED APPLICATION

This application claims benefit of U.S. Provisional Application No. 63/149,540, filed Feb. 15, 2021, which is incorporated herein by reference in its entirety.

### TECHNOLOGICAL FIELD

An example embodiment relates generally to supporting control of timing information for a terminal within a network.

### BACKGROUND

The 3rd Generation Partnership Project (3GPP) is a standards organization which develops protocols for mobile telephony and is known for the development and maintenance of various standards including second generation (2G), third generation (3G), fourth generation (4G), Long Term Evolution (LTE), and fifth generation (5G) standards. The 5G network has been designed as a Service Based Architecture (SBA), e.g., a system architecture in which the system functionality is achieved by Network Function (NF) sets providing services to other authorized NFs to access their services.

One method for extending the efficiency and flexibility of such networks is to leverage the infrastructure of various Public Land Mobile Networks (PLMNs). A User Equipment (UE) may operate outside of an associated Home Public Land Mobile Network (HPLMN) by using a Visited Public Land Mobile Network (VPLMN). However, certain VPLMNs may be preferred by the HPLMN because of specific agreements between each respective operator. To accommodate preferred PLMN selections, the 3GPP has developed the control plane Steering of Roaming (SOR) feature to facilitate the movement of a UE across different VPLMNs as desired by the UE's HPLMN.

By utilizing the control plane SOR an HPLMN can securely transmit a list of combination of PLMN and Access Technology (PLMN-AT) to a UE by way of a current VPLMN connection with the UE. The UE can then select VPLMNs preferred by the HPLMN based on the received PLMN and access technology combination data. The PLMN and access technology combination data is delivered to the UE via a connected VPLMN with an SOR transparent container. If the VPLMN alters or fails to forward the SOR transparent container to the UE, these actions are detectable. Moreover, the UE can only select a different VPLMN if the UE transitions to idle mode which requires a UE to maintain the current VPLMN connection.

### BRIEF SUMMARY

A method, apparatus, and computer program product are disclosed which provide for the identification of whether a UE supports Connected Mode Control Information (CMCI) so as to facilitate controlling the UE's time to stay in a particular network. A UE may determine, based on the CMCI, when to leave a current VPLMN. By securely delivering timing information, such as SOR-CMCI, and a PLMN-AT list to the UE (e.g., from the HPLMN via the VPLMN), some embodiments of the present disclosure may control the timing for when the UE can select and move to a different VPLMN. Compatibility with the SOR-CMCI is not a universally supported feature of all UEs and therefore identification of UEs supporting SOR-CMCI is required to allow for efficient and reliable VPLMN switching. For UEs that do not support SOR-CMCI a legacy SOR transparent container may be provided to the UE and for UEs that do support the SOR-CMCI then a new format SOR transparent container may be provided to the UE. The legacy SOR transparent container can only carry the PLMN-AT list. The new format SOR transparent container, henceforth the SOR transparent container, may comprise one or more of a PLMN-AT list or SOR-CMCI.

In some embodiments of the present disclosure, the PLMN-AT list, SOR-CMCI, and/or any other SOR information (e.g., an indication whether a UE supports SOR-CMCI or not) may be stored via a Unified Data Repository (UDR), a Steering of Roaming Application Function (SOR-AF), and/or one or more databases. The PLMN-AT list, SOR-CMCI, and/or any other SOR information stored via at least the UDR, and/or the SOR-AF, may be associated with one or more identifiers (e.g., Permanent Equipment Identifier (PEI), or the like) indicating at least an associated UE. For example, the UDR may store at least the PLMN-AT list, SOR-CMCI, and/or any other SOR information along with a PEI for any UEs identified by the HPLMN or the like. The UDR and/or SOR-AF may be configured to facilitate retrieval of the PLMN-AT list, SOR-CMCI, and/or any other SOR information stored therewith, by one or more network functions (e.g., Unified Data Management function (UDM), an Access and Mobility Management Function (AMF), or any other network function as described herein). For example, a UDM associated with an HPLMN made request determination of whether a UE supports SOR-CMCI or not, based on a UE's PEI, from a UDR. A request for SOR information may comprise a PEI and/or existing parameters associated with one or more PLMNs (e.g., local policies, Service Level Agreement (SLA) information, or the like), and/or the UE associated with the PEI. The UDR and/or the SOR-AF may generate a response to a request for SOR information that may, or may not, include SOR-CMCI based on the UE's support for SOR-CMCI and/or any other local policies of the PLMN or the like.

In some embodiments, the UDM may generate and/or cause transmission of an SOR information request message to the UDR and/or SOR-AF requesting SOR information associated with a particular UE. In some embodiments, the SOR information request message may comprise the UE's PEI. In some embodiments, the UDR and/or SOR-AF may determine, based on at least the PEI, whether or not the UE supports, or is compatible with, SOR-CMCI. In an instance, the UDR determines that the UE supports SOR-CMCI, the UDR and/or SOR-AF may include the SOR-CMCI in an SOR information response message to the UDM.

In some embodiments of the present disclosure, a UE that supports SOR-CMCI is configured to indicate that it supports SOR-CMCI via the SOR transparent container. The SOR transparent container may be a secure container generated using one or more of an integrity protection technique, credentialing technique, authentication technique, encryption technique, or similar security techniques for verifying that the SOR transparent container is not modified by an intermediary network entity (e.g., network functions between the UE and the HPLMN). For example, a UDM associated with the HPLMN may utilize a message authentication check to determine that the SOR transparent container was, or was not, changed by a network entity (e.g., a network function of the VPLMN) after it was transmitted from the UE. The SOR transparent container may comprise a support indicator indicating whether a UE supports SOR-CMCI or not. The support indicator indicating whether the UE supports SOR-CMCI or not may be configured as a single bit of information included in the SOR header of the SOR transparent container. In order to ensure that any VPLMN network function (e.g., AMF) forwards the SOR transparent container to the HPLMN irrespective of the release to which the VPLMN network function conforms, the SOR transparent container is conveyed (e.g., transmitted, received, etc.) via an existing Non-Access Stratum (NAS) message (e.g. REGISTRATION COMPLETE message, UL NAS TRANSPORT message), which contains the SOR transparent container from the initial protocol release.

In some embodiments, the UDM may not know whether the UE supports SOR-CMCI or not and, in response, when the UDM sends the SOR transparent container during the registration, the UDM may not include the SOR-CMCI in the SOR transparent container even if the SOR-CMCI for the UE is available.

In some embodiments, the UE supports SOR-CMCI and, in response, the REGISTRATION COMPLETE message (e.g., generated by the UE) includes at least an support indication indicating that the UE supports, or is compatible with, SOR-CMCI (e.g., provided via the SOR transparent container). In some embodiments, the support indication may be configured as a single bit of information configured into the SOR header of the SOR transparent container that ensures that the VPLMN cannot change or skip this information. In some embodiments, the single bit of information may be configured as a security and/or authentication feature for the SOR transparent container. In some embodiments, the UDM may receive a support indication that the UE supports, or is compatible with, SOR-CMCI and, in response, the UDM may be enabled/configured to cause transmission of SOR-CMCI from then on for the respective UE associated with the respective support indication.

According to an aspect of the present disclosure, there is provided an apparatus that comprises at least one processor and at least one memory with the at least one memory including computer program code, that is configured to, with the at least one processor, cause the apparatus at least to receive, from a network function, a request for a user equipment's steering of roaming information. The apparatus may be further caused to at least determine, based on the request, whether user equipment supports steering of roaming connected mode control information. The apparatus may be further caused to at least cause transmission, to the network function, of a response to the request.

In some embodiments, the apparatus may be further caused to at least include, in the response, at least the steering of roaming connected mode control information in an instance in which the user equipment is determined to support steering of roaming mode control information. In some embodiments of the apparatus, the request comprises a permanent equipment identifier for the user equipment. In some embodiments of the apparatus, the response is associated with the user equipment. In some embodiments of the apparatus, the network function comprises a unified data management.

According to an aspect of the present disclosure, there is provided a computer program product that comprises at least a non-transitory computer readable storage medium having program code portions stored thereon with the program code portions being configured, upon execution, by at least a processor, to receive, from a network function, a request for a user equipment's steering of roaming information. The computer program product may be further configured, upon execution, by at least the processor, to at least determine, based on the request, whether user equipment supports steering of roaming connected mode control information. The computer program product may be further configured, upon execution, by at least the processor, to at least cause transmission, to the network function, of a response to the request.

In some embodiments, the computer program product may be further configured, upon execution, by at least the processor, to at least include, in the response, at least the steering of roaming connected mode control information in an instance in which the user equipment is determined to support steering of roaming mode control information. In some embodiments of the computer program product, the request comprises a permanent equipment identifier for the user equipment. In some embodiments of the computer program product, the response is associated with the user equipment. In some embodiments of the computer program product, the network function comprises a unified data management.

According to an aspect of the present disclosure, there is provided a method that comprises receiving, from a network function, a request for a user equipment's steering of roaming information. The method may further comprise determining, based on the request, whether user equipment supports steering of roaming connected mode control information. The method may further comprise causing transmission, to the network function, of a response to the request.

In some embodiments, the method may further comprise including, in the response, at least the steering of roaming connected mode control information in an instance in which the user equipment is determined to support steering of roaming mode control information. In some embodiments of the method, the request comprises a permanent equipment identifier for the user equipment. In some embodiments of the method, the response is associated with the user equipment. In some embodiments of the method, the network function comprises a unified data management.

According to an aspect of the present disclosure, there is provided an apparatus that comprises means for receiving, from a network function, a request for a user equipment's steering of roaming information. The apparatus may further comprise means for determining, based on the request, whether user equipment supports steering of roaming connected mode control information. The apparatus may further comprise means for causing transmission, to the network function, of a response to the request.

In some embodiments, the apparatus may further comprise means for including, in the response, at least the steering of roaming connected mode control information in an instance in which the user equipment is determined to support steering of roaming mode control information. In some embodiments of the apparatus, the request comprises a permanent equipment identifier for the user equipment. In some embodiments of the apparatus, the response is associated with the user equipment. In some embodiments of the apparatus, the network function comprises a unified data management.

According to an aspect of the present disclosure, there is provided an apparatus that comprises at least one processor and at least one memory with the at least one memory including computer program code, that is configured to, with the at least one processor, cause the apparatus at least to cause transmission, to at least a network function, of a request for a user equipment's steering of roaming information. The apparatus may be further caused to at least receive, from at least the network function, a response to the request, wherein the request includes a permanent equipment identifier for the user equipment.

In some embodiments, the apparatus may be further caused to at least encode a steering of roaming transparent container according to: a first rule in an instance in which steering of roaming connected mode control information is included in the response. In some embodiments, the apparatus may be further caused to at least encode a steering of roaming transparent container according to: a second rule in an instance in which steering of roaming connected mode control information is not included in the response. In some embodiments, the apparatus may be further caused to at least cause transmission of the steering of roaming transparent container to the user equipment, wherein the response may or may not include the steering of roaming connected mode control information depending at least on the equipment identifier. In some embodiments of the apparatus, the network function comprises one or more of a unified data repository or a steering of roaming application function.

According to an aspect of the present disclosure, there is provided a computer program product that comprises at least a non-transitory computer readable storage medium having program code portions stored thereon with the program code portions being configured, upon execution, by at least a processor, to cause transmission, to at least a network function, of a request for a user equipment's steering of roaming information The computer program product may be further configured, upon execution, by at least the processor, to at least receive, from at least the network function, a response to the request, wherein the request includes a permanent equipment identifier for the user equipment.

In some embodiments, the computer program product may be further configured, upon execution, by at least the processor, to at least encode a steering of roaming transparent container according to: a first rule in an instance in which steering of roaming connected mode control information is included in the response. In some embodiments, the computer program product may be further configured, upon execution, by at least the processor, to at least encode a steering of roaming transparent container according to: a second rule in an instance in which steering of roaming connected mode control information is not included in the response. In some embodiments, the computer program product may be further configured, upon execution, by at least the processor, to at least cause transmission of the steering of roaming transparent container to the user equipment, wherein the response may or may not include the steering of roaming connected mode control information depending at least on the equipment identifier. In some embodiments of the computer program product, the network function comprises one or more of a unified data repository or a steering of roaming application function.

According to an aspect of the present disclosure, there is provided a method that comprises causing transmission, to at least a network function, of a request for a user equipment's steering of roaming information. The method may further comprise receiving, from at least the network function, a response to the request, wherein the request includes a permanent equipment identifier for the user equipment.

In some embodiments, the method may further comprise encoding a steering of roaming transparent container according to: a first rule in an instance in which steering of roaming connected mode control information is included in the response. In some embodiments, the method may further comprise encoding a steering of roaming transparent container according to: a second rule in an instance in which steering of roaming connected mode control information is not included in the response. In some embodiments, the method may further comprise causing transmission of the steering of roaming transparent container to the user equipment, wherein the response may or may not include the steering of roaming connected mode control information depending at least on the equipment identifier. In some embodiments of the method, the network function comprises one or more of a unified data repository or a steering of roaming application function.

According to an aspect of the present disclosure, there is provided an apparatus that comprises means for causing transmission, to at least a network function, of a request for a user equipment's steering of roaming information. The apparatus may further comprise means for receiving, from at least the network function, a response to the request, wherein the request includes a permanent equipment identifier for the user equipment.

In some embodiments, the apparatus may further comprise means for encoding a steering of roaming transparent container according to: a first rule in an instance in which steering of roaming connected mode control information is included in the response. In some embodiments, the apparatus may further comprise means for encoding a steering of roaming transparent container according to: a second rule in an instance in which steering of roaming connected mode control information is not included in the response. In some embodiments, the apparatus may further comprise means for causing transmission of the steering of roaming transparent container to the user equipment, wherein the response may or may not include the steering of roaming connected mode control information depending at least on the equipment identifier. In some embodiments of the apparatus, the network function comprises one or more of a unified data repository or a steering of roaming application function.

According to an aspect of the present disclosure, there is provided an apparatus that comprises at least one processor and at least one memory with the at least one memory including computer program code, that is configured to, with the at least one processor, cause the apparatus at least to generate a registration complete message comprising a steering of roaming transparent container. The apparatus may be further caused to at least cause transmission of the registration complete message, wherein the steering of roaming transparent container includes at least a support indicator indicating whether a user equipment supports steering of roaming connected mode control information.

In some embodiments of the apparatus, the support indicator is included in a steering of roaming header of the steering of roaming transparent container. In some embodiments of the apparatus, the support indicator comprises a single bit of information.

According to an aspect of the present disclosure, there is provided a computer program product that comprises at least a non-transitory computer readable storage medium having program code portions stored thereon with the program code portions being configured, upon execution, by at least a processor, to generate a registration complete message comprising a steering of roaming transparent container. The computer program product may be further configured, upon execution, by at least the processor, to at least cause transmission of the registration complete message, wherein the steering of roaming transparent container includes at least a support indicator indicating whether a user equipment supports steering of roaming connected mode control information.

In some embodiments of the computer program product, the support indicator is included in a steering of roaming header of the steering of roaming transparent container. In some embodiments of the computer program product, the support indicator comprises a single bit of information.

According to an aspect of the present disclosure, there is provided a method that comprises generating a registration complete message comprising a steering of roaming transparent container. The method may further comprise causing transmission of the registration complete message, wherein the steering of roaming transparent container includes at least a support indicator indicating whether a user equipment supports steering of roaming connected mode control information.

In some embodiments of the method, the support indicator is included in a steering of roaming header of the steering of roaming transparent container. In some embodiments of the method, the support indicator comprises a single bit of information.

According to an aspect of the present disclosure, there is provided an apparatus that comprises means for generating a registration complete message comprising a steering of roaming transparent container. The apparatus may further comprise means for causing transmission of the registration complete message, wherein the steering of roaming transparent container includes at least a support indicator indicating whether a user equipment supports steering of roaming connected mode control information.

In some embodiments of the apparatus, the support indicator is included in a steering of roaming header of the steering of roaming transparent container. In some embodiments of the apparatus, the support indicator comprises a single bit of information.

Various other aspects are also described in the following detailed description and in the attached claims.

### BRIEF DESCRIPTION OF THE DRAWINGS

Having thus described certain example embodiments of the disclosure in general terms, reference will now be made to the accompanying drawings, which are not necessarily drawn to scale, and wherein:

FIG. 1 illustrates an example architecture for a communications network, according to some embodiments;

FIG. 2 illustrates an example architecture for a communications network, according to some embodiments;

FIG. 3 illustrates an example architecture for a communications network, according to some embodiments;

FIG. 4 illustrates an example computing device for communicating over communication networks with other network entities, according to some embodiments;

FIG. 5 is a flow diagram illustrating the signaling between network entities via an example network infrastructure, according to some embodiments;

FIG. 6 is a flow diagram illustrating the signaling between network entities via an example network infrastructure, according to some embodiments;

FIG. 7 is a flow diagram illustrating the signaling between network entities via an example network infrastructure, according to some embodiments;

FIG. 8 is a flow chart illustrating example operations performed, such as by a communication device or other client device, in accordance with some example embodiments;

FIG. 9 is a flow chart illustrating example operations performed, such as by a communication device or other client device, in accordance with some example embodiments; and

FIG. 10 is a flow chart illustrating example operations performed, such as by a communication device or other client device, in accordance with some example embodiments.

### DETAILED DESCRIPTION

Some embodiments of the present disclosure will now be described more fully hereinafter with reference to the accompanying drawings, in which some, but not all, embodiments of the present disclosure are shown. Indeed, various embodiments of the present disclosure can be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms can be used interchangeably to refer to data capable of being transmitted, received and/or stored in accordance with certain embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

Additionally, as used herein, the terms “node,” “entity,” “intermediary,” “intermediate entity,” “go-between,” and similar terms can be used interchangeably to refer to computers connected via, or programs running on, a network or plurality of networks capable of data creation, modification, deletion, transmission, receipt, and/or storage in accordance with an example embodiment of the present disclosure.

Additionally, as used herein, the terms “user equipment,” “user device,” “device,” “apparatus,” “mobile device,” “personal computer,” “laptop computer,” “laptop,” “desktop computer,” “desktop,” “mobile phone,” “tablet,” “smartphone,” “smart device,” “cellphone,” “computing device,” “communication device,” “user communication device,” “terminal,” and similar terms can be used interchangeably to refer to an apparatus, such as may be embodied by a computing device, configured to access a network or plurality of networks for at least the purpose of wired and/or wireless transmission of communication signals in accordance with certain embodiments of the present disclosure.

Additionally, as used herein, the terms “network,” “serving network,” and similar terms can be used interchangeably to refer to an end to end logical communication network, or portion thereof (e.g., a network slice), such as a Public Land Mobile Network (PLMN) (e.g., Home Public Land Mobile Network (HPLMN), Visited Public Land Mobile Network (VPLMN), or the like), Stand-Alone Non-Public Network (SNPN), a Public Network Integrated NPN (PNI-NPN), and/or a radio access network communicably connected thereto.

As used herein, a “computer-readable storage medium,” which refers to a non-transitory physical storage medium (e.g., volatile or non-volatile memory device), can be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc (BD), the like, or combinations thereof), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where certain embodiments are described to use a computer-readable storage medium, other types of computer-readable mediums can be substituted for or used in addition to the computer-readable storage medium in alternative embodiments.

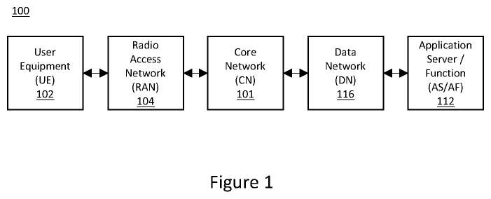

In the following, certain embodiments are explained with reference to communication devices capable of communication via a wired and/or wireless network and communication systems serving such communication devices. Before explaining in detail certain example embodiments, certain general principles of a wired and/or wireless communication system, access systems thereof, and communication devices are briefly explained with reference to FIGS. 1-4 to assist in understanding the technology underlying the described examples.

According to some embodiments, a communication device or terminal can be provided for wireless access via cells, base stations, access points, the like (e.g., wireless transmitter and/or receiver nodes providing access points for a radio access communication system and/or other forms of wired and/or wireless networks), or combinations thereof. Such wired and/or wireless networks include, but are not limited to, networks configured to conform to 2G, 3G, 4G, LTE, 5G, and/or any other similar or yet to be developed future communication network standards. The present disclosure contemplates that any methods, apparatuses, computer program codes, and any portions or combination thereof can also be implemented with yet undeveloped communication networks and associated standards as would be developed in the future and understood by one skilled in the art in light of the present disclosure.

Access points and hence communications there through are typically controlled by at least one appropriate control apparatus so as to enable operation thereof and management of mobile communication devices in communication therewith. In some embodiments, a control apparatus for a node can be integrated with, coupled to, and/or otherwise provided for controlling the access points. In some embodiments, the control apparatus can be arranged to allow communications between a user equipment and a core network or a network entity of the core network. For this purpose, the control apparatus can comprise at least one memory, at least one data processing unit such as a processor or the like, and an input/output interface (e.g., global positioning system receiver/transmitter, keyboard, mouse, touchpad, display, universal serial bus (USB), Bluetooth, ethernet, wired/wireless connections, the like, or combinations thereof).

Moreover, via the interface, the control apparatus can be coupled to relevant other components of the access point. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions can be distributed between several control units. In some embodiments, each base station can comprise a control apparatus. In alternative embodiments, two or more base stations can share a control apparatus.

Access points and associated controllers can communicate with each other via a fixed line connection and/or via a radio interface. The logical connection between the base station nodes can be provided for example by an X2 interface, an S1 interface, a similar interface, or combinations thereof. This interface can be used for example for coordination of operation of the stations and performing reselection or handover operations. The logical communication connection between the initial communication node and the final communication node of the network can comprise a plurality of intermediary nodes. Additionally, any of the nodes can be added to and removed from the logical communication connection as required to establish and maintain a network function communication.

The communication device or user equipment can comprise any suitable device capable of at least receiving a communication signal comprising data. The communication signal can be transmitted via a wired connection, a wireless connection, or combinations thereof. For example, the device can be a handheld data processing device equipped with radio receiver, data processing and user interface apparatus. Non-limiting examples include a mobile station (MS) such as a mobile phone or what is known as a ‘smart phone,’ a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, earpieces with wireless connectivity, jewelry and so on, Universal Serial Bus (USB) sticks with wireless capabilities, modem data cards, machine type devices or any combinations of these or the like.

In some embodiments, a communication device, e.g., configured for communication with the wireless network or a core network entity, can be exemplified by a handheld or otherwise mobile communication device or user equipment. A mobile communication device can be provided with wireless communication capabilities and appropriate electronic control apparatus for enabling operation thereof. Thus, the communication device can be provided with at least one data processing entity, for example a central processing unit and/or a core processor, at least one memory and other possible components such as additional processors and memories for use in software and hardware aided execution of tasks it is designed to perform. The data processing, storage, and other relevant control apparatus can be provided on an appropriate circuit board and/or in chipsets.

Data processing and memory functions provided by the control apparatus of the communication device are configured to cause control and signaling operations in accordance with certain embodiments as described later in this description. A user can control the operation of the communication device by means of a suitable user interface such as touch sensitive display screen or pad and/or a keypad, one of more actuator buttons, voice commands, combinations of these, or the like. A speaker and a microphone are also typically provided. Furthermore, a mobile communication device can comprise appropriate connectors (either wired or wireless) to other devices and/or for connecting external accessories, for example hands-free equipment, thereto.

In some embodiments, a communication device can communicate wirelessly via one or more appropriate apparatuses for receiving and transmitting signals (e.g., global positioning system receiver/transmitter, remote touchpad interface with remote display, Wi-Fi interface, etc.). In some embodiments, a radio unit can be connected to the control apparatus of the device. The radio unit can comprise a radio part and associated antenna arrangement. The antenna arrangement can be arranged internally or externally to the communication device.

FIGS. 1-3 illustrate various example architectures for a communications network 100 in which the various methods, apparatuses, and computer program products can be carried out and/or used. In some embodiments, the communications network 100 can comprise any suitable configuration, number, orientation, positioning, and/or dimensions of components and specialized equipment configured to provide an air interface (e.g., New Radio (NR)) for communication or connection between a User Equipment 102 (UE 102) and a Data Network 116 (DN 116) via a Core Network 101 (CN 101) of the communications network 100. The UE 102 can be associated with one or more devices associated with one or more network function (NF) service consumers.

As illustrated in FIG. 1, a communications network 100 can be provided in which the UE 102 is in operable communication with the Radio Access Network 104 (RAN 104), such as by way of a transmission tower, a base station, an access point, a network node, and/or the like. In some embodiments, the RAN 104 can communicate with the CN 101 or a component or entity thereof. In some embodiments, the CN 101 can facilitate communication between the UE 102 and the DN 116, such as for sending data, messages, requests, the like, or combinations thereof. In some embodiments, the DN 116 or the CN 101 can be in communication with an Application Server or Application Function 112 (AS/AF 112). The RAN 104, CN 101, DN 116, and/or AS/AF 112 can be associated with a Network Repository Function (NRF), NF service producer, Service Communication Proxy (SCP), Security Edge Protection Proxy (SEPP), Policy Charging Function (PCF), the like, or combinations thereof.

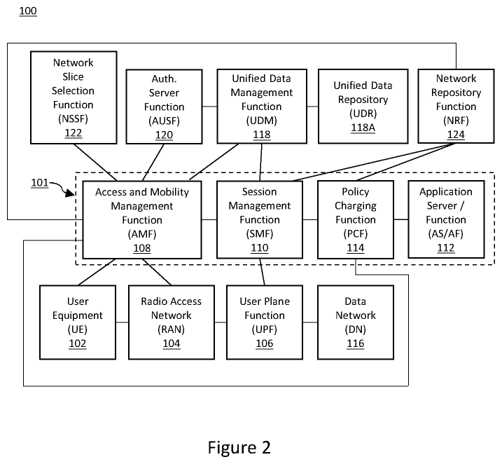

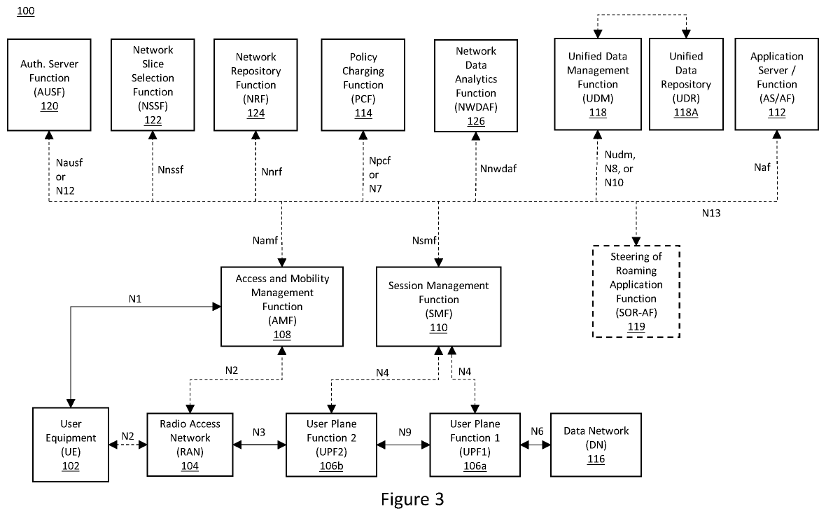

In the context of, for example, a 5G network, such as illustrated in FIGS. 2 and 3, the communications network 100 can comprise a series of connected network devices and specialized hardware that is distributed throughout a service region, state, province, city, or country, and one or more network entities, which can be stored at and/or hosted by one or more of the connected network devices or specialized hardware. In some embodiments, the UE 102 can connect to the RAN 104, which can then relay the communications between the UE 102 and the CN 101, the CN 101 being connected to the DN 116, which can be in communication with one or more AS/AF 112. Multiple communication networks as described herein, such as communications network 100, may be configured to communicate with each other.

In some embodiments, the UE 102 can be in communication with a RAN 104, which can act as a relay between the UE 102 and other components or services of the CN 101. For instance, in some embodiments, the UE 102 can communicate with the RAN 104, which can in turn communicate with an Access and Mobility Management Function 108 (AMF 108). In other instances or embodiments, the UE 102 can communicate directly with the AMF 108. In some embodiments, the AMF 108 can be in communication with one or more network functions (NFs), such as an Authentication Server Function 120 (AUSF 120), a Network Slice Selection Function 122 (NSSF 122), a Network Repository Function 124 (NRF 124), a Policy Charging Function 114 (PCF 114), a Unified Data Management function 118 (UDM 118), a Unified Data Repository 118A (UDR 118A), the AS/AF 112, a Session Management Function 110 (SMF 110), and/or the like. In some embodiments, the UDM 118 may comprise, at least partially, the UDR 118A or a network/application function thereof

In some embodiments, the SMF 110 can be in communication with one or more User Plane Functions 106 (UPF 106, UPF 106a, UPF 106b, collectively “UPF 106”). By way of example, in some embodiments, the UPF 106 can be in communication with the RAN 104 and the DN 116. In other embodiments, the DN 116 can be in communication with a first UPF 106a and the RAN 104 can be in communication with a second UPF 106b, while the SMF 110 is in communication with both the first and second UPFs 106a, b and the first and second UPFs 106a, b are in communication each with the other.

In some embodiments, the UE 102 can comprise a single-mode or a dual-mode device such that the UE 102 can be connected to one or more RANs 104. In some embodiments, the RAN 104 can be configured to implement one or more Radio Access Technologies (RATs), such as Bluetooth, Wi-Fi, and Global System for Mobile Communication (GSM), Universal Mobile Telecommunications System (UMTS), LTE or 5G NR, among others, that can be used to connect the UE 102 to the CN 101. In some embodiments, the RAN 104 can comprise or be implemented using a chip, such as a silicon chip, in the UE 102 that can be paired with or otherwise recognized by a similar chip in the CN 101, such that the RAN 104 can establish a connection or line of communication between the UE 102 and the CN 101 by identifying and pairing the chip within the UE 102 with the chip within the CN 101. In some embodiments, the RAN 104 can implement one or more base stations, towers or the like to communicate between the UE 102 and the AMF 108 of the CN 101.

In some embodiments, the communications network 100 or components thereof (e.g., base stations, towers, etc.) can be configured to communicate with a communication device (e.g., the UE 102) such as a cell phone or the like over multiple different frequency bands, e.g., FR1 (below 6 GHz), FR2 (mm Wave), other suitable frequency bands, sub-bands thereof, and/or the like. In some embodiments, the communications network 100 can comprise or employ massive Multiple Input and Multiple Output (MIMO) antennas. In some embodiments, the communications network 100 can comprise Multi-User MIMO (MU-MIMO) antennas. In some embodiments, the communications network 100 can employ edge computing whereby the computing servers are communicatively, physically, computationally, and/or temporally closer to the communications device (e.g., UE 102) in order to reduce latency and data traffic congestion. In some embodiments, the communications network 100 can employ other technologies, devices, or techniques, such as small cell, low-powered RAN, beamforming of radio waves, Wi-Fi cellular convergence, Non-Orthogonal Multiple Access (NOMA), channel coding, the like, or combinations thereof.

As illustrated in FIG. 3, the UE 102 can be configured to communicate with the RAN 104 in a N1 interface, e.g., according to a Non-Access Stratum (NAS) protocol. In some embodiments, RAN 104 can be configured to communicate with the CN 101 or a component thereof (e.g., the AMF 108) in a N2 interface, e.g., in a control plane between a base station of the RAN 104 and the AMF 108. In some embodiments, the RAN 104 can be configured to communicate with the UPF 106 in an N3 interface, e.g., in a user plane. In some embodiments, the AMF 108 and/or the SMF 110 can be configured to communicate with other services or network entities within the CN 101 in various different interfaces and/or according to various different protocols. For instance, in some embodiments, the AMF 108 and/or the SMF 110 can be configured to communicate with the AUSF 120 in an Nausf interface or an N12 interface.

In some embodiments, the AMF 108 and/or the SMF 110 can be configured to communicate with the NSSF 122 in an Nnssf interface. In some embodiments, the AMF 108 and/or the SMF 110 can be configured to communicate with the NRF 124 in an Nnrf interface. In some embodiments, the AMF 108 and/or the SMF 110 can be configured to communicate with the PCF 114 in an Npcf interface or an N7 interface. In some embodiments, the AMF 108 and/or the SMF 110 can be configured to communicate with the NWDAF 126 in an Nnwdaf interface. In some embodiments, the AMF 108 and/or the SMF 110 can be configured to communicate with the UDM 118 and/or the UDR 118A in an Nudm interface, an N8 interface, or an N10 interface. In some embodiments, the AMF 108 and/or the SMF 110 can be configured to communicate with the AS/AF 112 in an Naf interface. In some embodiments, the SMF 110 can be configured to communicate with the UPF 106 in an N4 interface, which can act as a bridge between the control plane and the user plane, such as acting as a conduit for a Protocol Data Unit (PDU) session during which information is transmitted between, e.g., the UE 102 and the CN 101 or components/services thereof.

In some embodiments, the AMF 108, the SMF 110, UDM 118, and/or the UDR 118A can be configured to communicate with the Steering of Roaming Application Function 119 (SOR-AF 119) via one or more of the interfaces described above. In some embodiments, one or more of the network functions, application functions, or repositories (as described herein) of a first network (e.g., VPLMN, HPLMN, etc.) may be configured to communicate with (e.g., retrieve, request, receive, and/or cause transmission of data to/from) one or more of the network functions, application functions, or repositories (as described above) of a second network (e.g., VPLMN, HPLMN, etc.).

It will be appreciated that certain example embodiments described herein arise in the context of a telecommunications network, including but not limited to a telecommunications network that conforms to and/or otherwise incorporates aspects of a fifth-generation (5G) architecture. While FIGS. 1-3 illustrate various configurations and/or components of an example architecture of the communications network 100, many other systems, system configurations, networks, network entities, and pathways/protocols for communication therein are contemplated and considered within the scope of this present disclosure.

While the methods, devices/apparatuses, and computer program products/codes described herein are described within the context of a fifth-generation core network (5GC) and system, such as illustrated in FIGS. 1-3 and described hereinabove, the described methods, devices, and computer program products can nevertheless be applied in a broader context within any suitable telecommunications system, network, standard, and/or protocol. It will be appreciated that the described methods, devices, and computer program products can further be applied to yet undeveloped future networks and systems as would be apparent to one skilled in the art in light of the present disclosure.

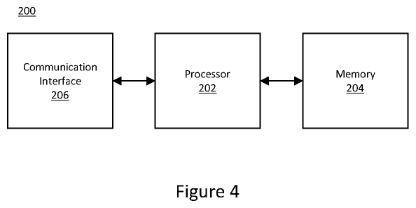

Turning now to FIG. 4, examples of an apparatus that may be embodied by the user equipment or by a network entity, such as server or other computing device are depicted in accordance with an example embodiment of the present disclosure. As described below in conjunction with the flowcharts and block diagrams presented herein, the apparatus 200 of an example embodiment can be configured to perform the functions described herein. In any instance, the apparatus 200 can more generally be embodied by a computing device, such as a server, a personal computer, a computer workstation or other type of computing device including those functioning as a user equipment and/or a component of a wireless network or a wireless local area network. Regardless of the manner in which the apparatus 200 is embodied, the apparatus of an example embodiment can be configured as shown in FIG. 4 so as to include, be associated with or otherwise be in communication with a processor 202 and a memory device 204 and, in some embodiments, and/or a communication interface 206.

Although not illustrated, the apparatus of an example embodiment may also optionally include a user interface, such as a touch screen, a display, a keypad, the like, or combinations thereof. Moreover, the apparatus according to an example embodiment can be configured with a global positioning circuit that comprises a global positioning receiver and/or global positioning transmitter configured for communication with one or more global navigation satellite systems (e.g., GPS, GLONASS, Galileo, the like, or combinations thereof). The global positioning circuit may be configured for the transmission and/or receipt of direct/indirect satellite and/or cell signals in order to determine geolocation data (e.g., latitude, longitude, elevation, altitude, geographic coordinates, the like, or combinations thereof) for the apparatus and/or another communication device associated with the apparatus or the one or more global navigation satellite systems.

In some embodiments, geolocation data may comprise a time dimension, such as a time stamp that associates the geolocation data with a respective time (e.g., 01:00 AM EST, etc.), a respective date (e.g., Sep. 26, 2020, etc.), and/or the like. The time dimension may be configured based on one or more of a time of receipt, generation, transmission, and/or the like (e.g., by the apparatus). In some embodiments, geolocation data may be associated with one or more time dimensions.

The processor 202 (and/or co-processors or any other circuitry assisting or otherwise associated with the processor) can be in communication with the memory device 204 via a bus for passing information among components of the apparatus 200. The memory device can include, for example, one or more volatile and/or non-volatile memories, such as a non-transitory memory device. In other words, for example, the memory device can be an electronic storage device (e.g., a computer readable storage medium) comprising gates configured to store data (e.g., bits) that can be retrievable by a machine (e.g., a computing device like the processor). The memory device can be configured to store information, data, content, applications, instructions, the like, or combinations thereof for enabling the apparatus to carry out various functions in accordance with an example embodiment. For example, the memory device could be configured to buffer input data for processing by the processor. Additionally or alternatively, the memory device could be configured to store instructions for execution by the processor.

The apparatus 200 can, in some embodiments, be embodied in various computing devices as described above. However, in some embodiments, the apparatus can be embodied as a chip or chip set. In other words, the apparatus can comprise one or more physical packages (e.g., chips) including materials, components and/or wires on a structural assembly (e.g., a baseboard). The structural assembly can provide physical strength, conservation of size, and/or limitation of electrical interaction for component circuitry included thereon. The apparatus can therefore, in some cases, be configured to implement an embodiment of the present disclosure on a single chip or as a single “system on a chip.” As such, in some cases, a chip or chipset can constitute means for performing one or more operations for providing the functionalities described herein.

The processor 202 can be embodied in a number of different ways. For example, the processor can be embodied as one or more of various hardware processing means such as a coprocessor, a microprocessor, a controller, a Digital Signal Processor (DSP), a processing element with or without an accompanying DSP, or various other circuitry including integrated circuits such as, for example, an Application Specific Integrated Circuit (ASIC), a Field Programmable Gate Array (FPGA), a Micro-Controller Unit (MCU), a hardware accelerator, a special-purpose computer chip, or the like. As such, in some embodiments, the processor can include one or more processing cores configured to perform independently. A multi-core processor can enable multiprocessing within a single physical package. Additionally or alternatively, the processor can include one or more processors configured in tandem via the bus to enable independent execution of instructions, pipelining and/or multithreading.

In an example embodiment, the processor 202 can be configured to execute instructions stored in the memory device 204 or otherwise accessible to the processor. Alternatively or additionally, the processor can be configured to execute hard coded functionality. As such, whether configured by hardware or software methods, or by a combination thereof, the processor can represent an entity (e.g., physically embodied in circuitry) capable of performing operations according to an embodiment of the present disclosure while configured accordingly. Thus, for example, when the processor is embodied as an ASIC, FPGA, the like, or combinations thereof the processor can be specifically configured hardware for conducting the operations described herein.

Alternatively, as another example, when the processor is embodied as an executor of instructions, the instructions can specifically configure the processor to perform the algorithms and/or operations described herein when the instructions are executed. However, in some cases, the processor can be a processor of a specific device (e.g., an encoder and/or a decoder) configured to employ an embodiment of the present disclosure by further configuration of the processor by instructions for performing the algorithms and/or operations described herein. The processor can include, among other things, a clock, an Arithmetic Logic Unit (ALU) and logic gates configured to support operation of the processor.

In some embodiments that include a communication interface 206, the communication interface can be any means such as a device or circuitry embodied in either hardware or a combination of hardware and software that is configured to receive and/or transmit data from/to a network and/or any other device or module in communication with the apparatus 200, such as network functions, network repository functions, a base station, an access point, service communication proxies, UE 102, RAN 104, core network services, AS/AF 112, a database or other storage device, the like, or combinations thereof In this regard, the communication interface can include, for example, one or more antennas and supporting hardware and/or software for enabling communications with a wireless communication network. Additionally or alternatively, the communication interface can include the circuitry for interacting with the one or more antennas to cause transmission of signals via the one or more antennas or to handle receipt of signals received via the one or more antennas.

In some embodiments, the one or more antennas may comprise one or more of a dipole antenna, monopole antenna, helix antenna, loop antenna, waveguide, horn antenna, parabolic reflectors, corner reflectors, dishes, micro strip patch array, convex-plane, concave-plane, convex-convex, concave-concave lenses, the like or combinations thereof. In some environments, the communication interface can alternatively or also support wired communication. As such, for example, the communication interface can include a communication modem and/or other hardware/software for supporting communication via cable, Digital Subscriber Line (DSL), USB, the like or combinations thereof.

In some embodiments, a session management function (e.g., SMF 110) can comprise a 5GC session management function for any suitable Control and User Plane Separation (CUPS) architecture, such as for the General Packet Radio Service (GPRS), Gateway GPRS Support Node Control plane function (GGSN-C), Trusted Wireless Access Gateway Control plane function (TWAG-C), Broadband Network Gateway Control and User Plane Separation (BNG-CUPS), N4 interface, Sxa interface, Sxb interface, Sxc interface, Evolved Packet Core (EPC) Serving Gateway Control plane function (SGW-C), EPC Packet Data Network Gateway Control plane function (PGW-C), EPC Traffic Detection Control plane function (TDF-C), the like, or combinations thereof.

As illustrated, the apparatus 200 can include a processor 202 in communication with a memory 204 and configured to provide signals to and receive signals from a communication interface 206. In some embodiments, the communication interface 206 can include a transmitter and a receiver. In some embodiments, the processor 202 can be configured to control the functioning of the apparatus 200, at least in part. In some embodiments, the processor 202 can be configured to control the functioning of the transmitter and receiver by effecting control signaling via electrical leads to the transmitter and receiver. Likewise, the processor 202 can be configured to control other elements of apparatus 200 by effecting control signaling via electrical leads connecting the processor 202 to the other elements, such as a display or the memory 204.

The apparatus 200 can be capable of operating with one or more air interface standards, communication protocols, modulation types, access types, and/or the like. Signals sent and received by the processor 202 can include signaling information in accordance with an air interface standard of an applicable cellular system, and/or any number of different wireline or wireless networking techniques, comprising but not limited to Wi-Fi, Wireless Local Access Network (WLAN) techniques, such as Institute of Electrical and Electronics Engineers (IEEE) 802.11, 802.16, 802.3, Asymmetric Digital Subscriber Line (ADSL), Data Over Cable Service Interface Specification (DOCSIS), the like, or combinations thereof. In addition, these signals can include speech data, user generated data, user requested data, the like, or combinations thereof.

For example, the apparatus 200 and/or a cellular modem therein can be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, Session Initiation Protocol (SIP)), the like, or combinations thereof. For example, the apparatus 200 can be capable of operating in accordance with 2G wireless communication protocols Interim Standard (IS) 136 (IS-136), Time Division Multiple Access (TDMA), GSM, IS-95, Code Division Multiple Access, Code Division Multiple Access (CDMA), the like, or combinations thereof. In addition, for example, the apparatus 200 can be capable of operating in accordance with 2.5G wireless communication protocols GPRS, Enhanced Data GSM Environment (EDGE), the like, or combinations thereof

Further, for example, the apparatus 200 can be capable of operating in accordance with 3G wireless communication protocols, such as UMTS, Code Division Multiple Access 2000 (CDMA2000), Wideband Code Division Multiple Access (WCDMA), Time Division-Synchronous Code Division Multiple Access (TD-SCDMA), the like, or combinations thereof. The NA 200 can be additionally capable of operating in accordance with 3.9G wireless communication protocols, such as Long Term Evolution (LTE), Evolved Universal Terrestrial Radio Access Network (E-UTRAN), the like, or combinations thereof

Additionally, for example, the apparatus 200 can be capable of operating in accordance with 4G wireless communication protocols, such as LTE Advanced, 5G, and/or the like as well as similar wireless communication protocols that can be subsequently developed. In some embodiments, the apparatus 200 can be capable of operating according to or within the framework of any suitable CUPS architecture, such as for the gateway GGSN-C, TWAG-C, Broadband Network Gateways (BNGs), N4 interface, Sxa interface, Sxb interface, Sxc interface, EPC SGW-C, EPC PGW-C, EPC TDF-C, the like, or combinations thereof. Indeed, although described herein in conjunction with operation with a 5G system, the apparatus and method may be configured to operate in conjunction with a number of other types of systems including systems hereinafter developed and implemented.

Some of the example embodiments disclosed herein can be implemented in software, hardware, application logic, or a combination of software, hardware, and application logic. The software, application logic, and/or hardware can reside on memory 204, the processor 202, or electronic components, for example. In some example embodiments, the application logic, software or an instruction set is maintained on any one of various conventional computer-readable media. In the context of this document, a “computer-readable medium” can be any non-transitory media that can contain, store, communicate, propagate or transport the instructions for use by or in connection with an instruction execution system, apparatus, or device, such as a computer or data processor circuitry, with examples depicted at FIG. 4. The computer-readable medium can comprise a non-transitory computer-readable storage medium that can be any media that can contain or store the instructions for use by or in connection with an instruction execution system, apparatus, or device, such as a computer.

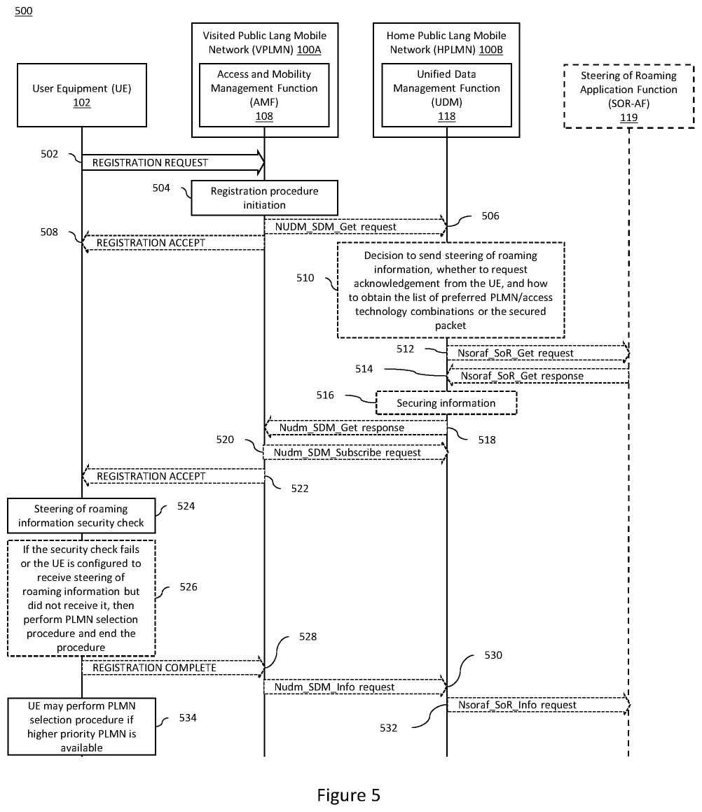

FIG. 5 illustrates a flow chart that depicts an example signal sequence 500, for the provision of timing information indicating a UE's CMCI compatibility/support for controlling of terminal timing within a network, between communication devices. Example signal sequence 500 is, at least partially, facilitated by way of a network infrastructure (e.g., communications network 100 or the like) and/or one or more communication interfaces (e.g., Communication Interface 206, or the like) of respective apparatuses. As shown, the example network infrastructure utilized for signal sequence 500 comprises at least the UE 102, AMF 108, UDM 118, and SOR-AF of 119. As shown, AMF 108 is associated with a VPLMN 100A and UDM 118 is associated with HPLMN 100B. The VPLMN 100A and the HPLMN 100B may be configured in accordance with one or more configurations of the communications network 100 as described by the present disclosure.

In some embodiments, the network infrastructure utilized with example signal sequence 500 may be configured with the necessary hardware (e.g., base stations, apparatuses for wired/wireless signaling, network function servers, or the like to execute example signal sequence 500) in accordance with 5G system standards, or the like (e.g., 4G, LTE, etc.). For example, the network infrastructure may be configured with one or more of a RAN (not shown), Next Generation Node B (gNB) (not shown) that can comprise one or more 5G radio nodes, such as one or more additional gNBs (not shown) or the like. Additionally, the AMF 108 may be hosted by a computing device (e.g., a server, etc.) associated with the VPLMN 100A and UDM 118 may be hosted by a computing device (e.g., a server, etc.) associated with HPLMN 100B. Moreover, the example signal sequence 500 may be implemented utilizing one or more network infrastructures associated with one or more networks (e.g., a PLMN, an SNPN, PNI-NPN, or the like.) via at least a shared RAN. In some embodiments, timing information comprises one or more of a PLMN-AT list (e.g., a HPLMN's preferred VPLMNs list, a VPLMN priority list, etc.), SOR-CMCI, a determination/indication of whether SOR-CMCI is supported by/compatible with a respective UE or not, or any other SOR information for facilitating VPLMN switching. In some embodiments, the SOR-AF 119 may be hosted by a server associated with one or more networks (e.g., VPLMN 100A, HPLMN 100B, or the like). In some embodiments, one or more of the messages/signals described below with respect to one or more of the example signal sequences (e.g., 500, 600, 700, or the like) may comprise one or more Radio Resource Control (RRC) messages or the like.

The example signal sequence 500 begins at block 502 when the UE 102 causes transmission of a REGISTRATION REQUEST message to the AMF 108 of VPLMN 100A. For example, the UE may initiate an initial registration, an emergency registration, or a mobility registration update procedure to the AMF 108 by sending the REGISTRATION REQUEST message with a 5G System (5GS) registration type indicating “initial registration”, “emergency registration”, or “mobility registration updating”.

Upon receipt of the registration request message, the AMF 108 causes initiation of the registration procedure, see block 504. As shown in block 506, the initiation of the registration procedure may comprise causing transmission of a NUDM SDM_Get request message from the AMF 108 of the VPLMN 100A to the UDM 118 of the HPLMN 100B. For example, if the AMF 108 of the VPLMN 100A does not have access to subscription data for the UE 102, then the AMF 108 invokes the Nudm_SDM_Get service operation to the UDM 118 of the HPLMN 100B to get amongst other information the subscription data (e.g., Access and Mobility Subscription data or the like) for the UE 102.

As further shown in block 508, the initiation of the registration procedure may comprise causing transmission of a REGISTRATION ACCEPT message from the AMF 108 to the UE 102. For example, if the AMF 108 of the VPLMN 100A already has subscription data for the UE 102, and either: (1) the 5GS registration type Information Element (IE) in the received REGISTRATION REQUEST message indicates “initial registration” and the “SoR Update Indicator for Initial Registration” field in the UE context is set to “the UDM requests the AMF to retrieve SOR information when the UE performs Non-Access Stratum (NAS) registration type ‘initial registration’”; or (2) the 5GS registration type IE in the received REGISTRATION REQUEST message indicates “emergency registration” and the “SoR Update Indicator for Emergency Registration” field in the UE context is set to “the UDM requests the AMF to retrieve SOR information when the UE performs NAS registration type ‘emergency registration’”, then the AMF 108 causes transmission of the Nudm_SDM_Get service operation message to the UDM 118 to retrieve the SOR information. Alternatively, the AMF 108 may cause transmission of the REGISTRATION ACCEPT message without the SOR information to the UE 102, thereby skipping the operations of blocks 510, 512, 514, 516, 518, 520, and 522.

At block 510, the UDM 118 determines, based on at least the NUDM SDM_Get request message received from the AMF 108, to cause transmission of SOR information to at least UE 102, to request an acknowledgement message response from the UE 102 upon the UE 102 receiving the SOR information, and/or how to obtain the PLMN-AT or the secured packet. In some embodiments, the PLMN-AT may comprise/include, a list of preferred PLMN indicating a priority list of PLMNs associated with the operator of the HPLMN 100B. For example, if the subscription data for the UE 102 indicates to cause transmission of the SOR information in response to initial registration in the VPLMN 100A, then the UDM 118 shall provide the SOR information to the UE when the UE performs initial registration in the VPLMN 100A, otherwise the UDM 118 may provide the SOR information to the UE 102, based on an operator policy (e.g., associated with the VPLMN 100A and/or HPLMN 100B). Moreover, if the UDM 118 receives PLMN-AT from, for example, the UDR 118A, and the UDM 118 supports communication with a Secured Packet Application Function (SP-AF), the UDM 118, Based on operator deployment and policy, may cause transmission of the PLMN-AT to the SP-AF requesting it to provide this information in a secured packet.

In an instance, the UDM 118 provides the SOR information to the UE 102 when the UE 102 performs a registration procedure with the VPLMN 100A, and if the HPLMN 100B's policy for the SOR-AF 119 invocation is absent then the Nsoraf SoR_Get request/response (described below for blocks 512 and 514 respectively) are not performed and the UDM 118 obtains the PLMN-AT and any available SOR-CMCI or the available secured packet, for example, are all retrieved from the UDR 118A. However, if the UE 102 does not support the SOR-CMCI, then the UDM 118 does not obtain at least the SOR-CMCI from the UDR 118. Moreover, if the UDM 118 is to provide the SOR information to the UE 102 when the UE 102 performs a registration procedure with the VPLMN 100A, and the HPLMN 100B's policy for the SOR-AF 119 invocation is present, then the UDM 118 obtains the PLMN-AT or the secured packet from the SOR-AF 119.

At block 512, the UDM 118 causes transmission of an Nsoraf SoR_Get request message to the SOR-AF 119. Upon receipt of the Nsoraf SoR_Get request message from the UDM 118, then the SOR-AF 119 generates and/or causes transmission of an Nsoraf SoR_Get response message to the UDM 118, see block 514. For example, the UDM 118 causes transmission to the SOR-AF 119 the Nsoraf SoR_Get request message comprising one or more of an identifier associated with the VPLMN 100A, a globally unique 5G Subscription Permanent Identifier (SUPI) associated with the UE 102, an access type, an access type parameter, or a PEI associated with at least the UE 102. Further, the identifier associated with the VPLMN 100A and the access type parameters that at least indicate where the UE 102 is registering, may be stored in the UDM 118, such as via the UDR 118A or the like. Moreover, if the UDM 118 supports causing transmission of the SOR-CMCI to the UE, then the UDM 118 may also include the PEI in the SOR-CMCI reporting message. If the PEI is included in the Nsoraf SoR_Get request, the SOR-AF 119 shall determine whether the UE supports the SOR-CMCI. For example, the SOR-AF 119 may comprise, or have access to, a data base and/or repository comprising at least a list of UEs that support, or are compatible with, SOR-CMCI at least partially organizable by the PEIs associated with the listed UEs. Moreover, the SOR-AF 119 may cause transmission of the SOR information (e.g., one or more of PLMN-AT, the SOR-CMCI, the secured packet, or the like), available to the SOR-AF 119 and determined based on at least a respective PEI, for a respective UE (e.g., UE 102 or the like) via the Nsoraf SoR_Get response message, or similar messages, to the UDM 118. The SOR-AF 119 may determine that the UE supports the SOR-CMCI based on the PEI received from the UDM 118, and based on that determination the SOR-AF may include at least the SOR-CMCI in the Nsoraf SoR_Get response message back to the UDM 118.

In some embodiments, when the access type where the UE 102 is registering indicates 3GPP access, then the UE 102 may be registering over an Next Generation (NG)-RAN access technology. In some embodiments, if the UDM 118 receives the list of preferred PLMN/access technology combinations in the Nsoraf SoR_Get response from the SOR-AF 119, and the UDM 118 supports communication with SP-AF, the UDM 118, based on operator deployment and policy, can cause transmission of the list to SP-AF requesting the SP-AF to provide this information in a secured packet. In some embodiments, the SOR-AF 119 can include a different list of preferred PLMN/access technology combinations or a different secured packet for each Nsoraf SoR Get request even if the same identifier associated with the VPLMN 100A, the same globally unique 5G SUPI associated with the UE 102, and the same access type are transmitted to the SOR-AF 119. In some embodiments, the SOR-AF 119 can subscribe to the UDM 118 to be notified about the changes of the roaming status of the UE 102 identified by SUPI.

At block 516, the UDM 118 generates the security information based on at least the Nsoraf SoR_Get response. For example, the UDM 118 generates the SOR information as based on at least the list of preferred PLMN/access technology combinations and the SOR-CMCI, and/or the secured packet. In an instance, neither the list of preferred PLMN/access technology combinations nor the secured packet was received, or the SOR-AF has not causes transmission of the list of preferred PLMN/access technology combinations or the secured packet to the UDM 118 via the Nsoraf SoR_Get response within an operator defined time after the UDM 118 transmits the Nsoraf SoR_Get request message to the SOR-AF, and the UE is performing initial registration with the VPLMN 100A, and the subscription data indicates to transmit the SOR information due to initial registration with the VPLMN 100A, then the UDM 118 may generate the SOR information based on the HPLMN 100B's indication that “no change of the ‘Operator Controlled PLMN Selector with Access Technology’ list stored in the UE is needed and thus no list of preferred PLMN/access technology combinations is provided”.

At block 518, the UDM 118 causes transmission of a Nudm_SDM_Get response to the AMF 108. Upon receipt of the Nudm_SDM_Get response the AMF 108 causes transmission of an Nudm_SDM Subscribe request back to the UDM 118, see block 520. For example, the UDM 118 causes transmission of the response to the Nudm_SDM_Get service operation to the AMF 108, the response comprising the SOR information within the subscription data (e.g., Access and Mobility Subscription data). The subscription data may comprise a data type (e.g., Access and Mobility Subscription data type). The HPLMN 100B may also request the UE 102 to acknowledge the successful security check of the received SOR information, by providing an indication as part of the SOR information in the Nudm_SDM_Get response service operation. Moreover, the AMF 108, as part of the registration procedure, may also generate/cause transmission of an Nudm_SDM Subscribe service operation to the UDM 118 to subscribe to notification of changes of the subscription data comprising a notification of updates of the SOR information included in, for example, the Access and Mobility Subscription data.

At block 522, the AMF 108 causes transmission of a REGISTRATION ACCEPT message to the UE 102. For example, the AMF 108 may transparently cause transmission of the received SOR information to the UE 102 via the REGISTRATION ACCEPT message comprising an SOR transparent container (as described herein). The UE 102, at block 524, performs an SOR information security check, based on at least the REGISTRATION ACCEPT message comprising an SOR transparent container. In an instance, the SOR information is received and the security check is successful, then the UE 102 may utilize the SOR information to request the SOR-CMCI, or if the SOR-CMCI has been included in the SOR transparent container, then the UE 102 may determines that there is a higher priority PLMN than the currently connected VPLMN 100A. Based on the determination that that there is a higher priority PLMN the UE 102 may cause one or more operations to switch from the VPLMN 100A to the higher priority PLMN. In some embodiments, the SOR transparent container may comprise a list of available and allowable (e.g., as determined the HPLMN 100B operator of UE 102) PLMNs in the UE's local area. In some embodiments, the SOR-CMCI is provided to the UE 102 via a REFRESH command. In some embodiments, the UE 102 determines that the SOR-CMCI requires that the UE 102 shall transition to an idle mode with VPLMN 100A.

Example signal sequence 500 continues to block 526, in an instance the security check fails and/or the UE is configured to receive SOR information but did not receive the SOR information, then the UE 102 may perform one or more PLMN selection procedures and end the procedure. For example, if the UE 102's Universal Subscriber Identity Module (USIM) is configured with an indication that the UE 102 is to receive the SOR information due to initial registration with the VPLMN 100A, but neither the list of preferred PLMN/access technology combinations, the secured packet, nor the HPLMN indication that “no change of the ‘Operator Controlled PLMN Selector with Access Technology’ list stored in the UE is needed and thus no list of preferred PLMN/access technology combinations is provided” is received in the REGISTRATION ACCEPT message, then when the UE performs initial registration with the VPLMN 100A or if the SOR information is received but the security check is not successful, then the UE 102 may cause transmission of the REGISTRATION COMPLETE message to the serving AMF 108 without including an SOR transparent container. Further, if the current chosen VPLMN 100A is not contained in the list of “PLMNs where registration was aborted due to SOR”, and is not part of “User Controlled PLMN Selector with Access Technology” list and the UE 102 is not in manual mode of operation, then the UE 102 may release the current N1 NAS signaling connection locally and attempt to obtain service on a higher priority PLMN and by acting as if timer ‘T’ that controls periodic attempts has expired, with an exception that the current PLMN is considered as the lowest priority. Additionally, the UE 102 may store the PLMN identity in the list of “PLMNs where registration was aborted due to SOR” via one or more databases/repositories as described herein. In some embodiments, the UE 102 may stay on the current VPLMN 100A.

At block 528, the UE 102 generates and/or causes transmission of a REGISTRATION COMPLETE message to the AMF 108 associated with VPLMN 100A. The REGISTRATION COMPLETE message may be provided to the AMF 108 by the UE 102 if the UDM 118 has requested an acknowledgement from the UE 102. For example, once the UE 102 verified that the SOR information has been provided by the HPLMN 100B, the UE 102 causes transmission of the REGISTRATION COMPLETE message to the serving AMF 108 with an SOR transparent container including the UE 102 acknowledgement.

At block 530, the AMF 108 generates/causes transmission of, based on at least the received REGISTRATION COMPLETE message, an Nudm_SDM_Info request message to UDM 118. For example, if an SOR transparent container is received in the REGISTRATION COMPLETE message, the AMF 108 uses the Nudm_SDM Info service operation to provide the received SOR transparent container to the UDM 118. Moreover, if the HPLMN 100B decided that the UE 102 is to acknowledge the successful security check of the received SOR information, the UDM 118 verifies that the acknowledgement is provided by the UE 102.

At block 532, the UDM 118 generates/causes transmission of, based on at least the received Nudm_SDM Info request, an Nsoraf_SoR_Info request to the SOR-AF 119. For example, upon receipt of the Nudm_SDM Info request, the UDM 118 may be configured to cause transmission of the Nsoraf_SoR_Info comprising a SUPI of the UE 102 and successful delivery indication acknowledgement associated with the UE 102. In an instance, the HPLMN 100B's policy for the SOR-AF 119 invocation (e.g., messaging, calling, etc.) is present and the UDM 118 received and/or verified the UE 102's acknowledgement, then the UDM 118 provides indication to the SOR-AF 119 of the successful delivery of the list of preferred PLMN/access technology combinations, and/or of the secured packet transmitted to the UE 102.

At block 534, the UE 102 may perform one or more PLMN selection procedures if at least a higher priority PLMN is available. For example, if the UE 102 has a list of available PLMNs in the UE 102's local area, and, based on at least this list, the UE 102 determines that there is a higher priority PLMN than the currently selected VPLMN 100A, and the UE 102 is in automatic network selection mode, then the UE shall attempt to obtain service on a higher priority PLMN by acting as if timer T that controls the periodic attempts to obtain service from another PLMN has expired after the release of the Ni NAS signaling connection. Moreover, if the Ni NAS signaling connection is not released after implementation dependent time, the UE 102 may locally release the Ni signaling connection except when the UE 102 has an established emergency PDU session.

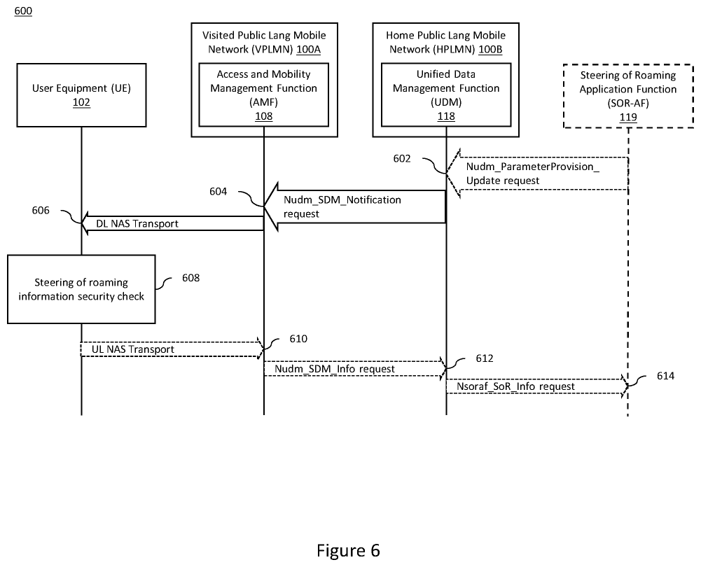

FIG. 6 illustrates a flow chart that depicts an example signal sequence 600, for the provision of timing information indicating a UE's CMCI compatibility/support for controlling of terminal timing within a network, between communication devices. The example signal sequence 600 may be performed, at least sometimes, after a UE has performed at least a portion of example signal sequence 500, for example, to update the UE's CMCI and/or switch to another serving PLMN (e.g., VPLMN, etc.). Example signal sequence 600 is, at least partially, facilitated by way of a network infrastructure (e.g., communications network 100 or the like) and/or one or more communication interfaces (e.g., Communication Interface 206, or the like) of respective apparatuses. As shown, the example network infrastructure utilized for signal sequence 600 comprises at least the UE 102, AMF 108, UDM 118, and SOR-AF of 119. As shown, AMF 108 is associated with a VPLMN 100A and UDM 118 is associated with HPLMN 100B. The VPLMN 100A and the HPLMN 100B may be configured in accordance with one or more configurations of the communications network 100 as described by the present disclosure.

In some embodiments, the network infrastructure utilized with example signal sequence 600 may be configured with the necessary hardware (e.g., base stations, apparatuses for wired/wireless signaling, network function servers, or the like to execute example signal sequence 600) in accordance with 5G system standards, or the like (e.g., 4G, LTE, etc.). For example, the network infrastructure may be configured with one or more of a RAN (not shown), Next Generation Node B (gNB) (not shown) that can comprise one or more 5G radio nodes, such as one or more additional gNBs (not shown) or the like. Additionally, the AMF 108 may be hosted by a computing device (e.g., a server, etc.) associated with the VPLMN 100A and UDM 118 may be hosted by a computing device (e.g., a server, etc.) associated with HPLMN 100B. Moreover, the example signal sequence 600 may be implemented utilizing one or more network infrastructures associated with one or more networks (e.g., a PLMN, an SNPN, PNI-NPN, or the like.) via at least a shared RAN. In some embodiments, timing information comprises one or more of a PLMN-AT list (e.g., a HPLMN's preferred VPLMNs list, a VPLMN priority list, etc.), SOR-CMCI, a determination/indication of whether SOR-CMCI is supported by/compatible with a respective UE or not, or any other SOR information for facilitating VPLMN switching. In some embodiments, the SOR-AF 119 may be hosted by a server associated with one or more networks (e.g., VPLMN 100A, HPLMN 100B, or the like).

The example signal sequence 600 begins at block 602 when the SOR-AF 119 generates/causes transmission of an Nudm_ParameterProvision Update request message to UDM 118, associated with HPLMN 100B. In some embodiments, the example signal sequence 600 may be initiated based on one or more procedures associated with example signal sequence 500 and/or the detection of a trigger condition (e.g., detection of a higher priority PLMN, a UE policy, a network policy, expiration of a timer, or the like). For example, the Nudm_ParameterProvision Update request message may be sent to the UDM 118 to trigger/cause the update of the UE 102 with a new list of preferred PLMN/access technology combinations, the SOR-CMCI, and/or a secured packet for a UE 102 identified by an associated with SUPI. In some embodiments, the UE 102 may be updated with any SOR information as descried herein. In an instance, the SOR-AF 119 determines that the UE 102 does support the SOR-CMCI during registration, the SOR-AF 119 may include at least the SOR-CMCI in the Nudm_ParameterProvision_Update request message.

At block 604, the UDM 118 generates/causes transmission of (e.g., based on at least receipt of the Nudm_ParameterProvision Update request message from the SOR-AF 119, or the like) an Nudm_SDM_Notification request to AMF 108 associated with VPLMN 100A. For example, the UDM 118 may notify any changes to the user profile (e.g., associated with the UE 102) to the affected AMF (e.g., AMF 108) by generating and then causing the transmission of the Nudm_SDM_Notification service operation to the affected AMF. In some embodiments, the Nudm_SDM_Notification service operation may contain the SOR information that needs to be delivered transparently (e.g., via the SOR transparent container, or the like) to the UE 102 over NAS within a subscription data (e.g., Access and Mobility Subscription data, or the like). In an instance, the SOR information is retrieved from the UDR 118A and the UE 102 does not support the SOR-CMCI, the SOR information (e.g., transmitted via the SOR transparent container, or the like) does not include the SOR-CMCI. In an instance, the HPLMN 100B determines that the UE 102 is to acknowledge the successful security check of the received SOR information (e.g., via the SOR transparent container, or the like), the Nudm_SDM_Notification service operation also contains an indication that the UDM 118 requests an acknowledgement from the UE 102 as part of the SOR information. Moreover, if the SOR-CMCI was obtained, the UDM 118 may include the SOR-CMCI into the SOR information.

At block 606, the AMF 108 generates/causes transmission of (e.g., based on at least receipt of the Nudm_SDM_Notification request from the UDM 118, or the like) a Down Link (DL) NAS Transport message to the UE 102. For example, the AMF 108 causes transmission of a DL NAS TRANSPORT message to the served UE (e.g., UE 102). The AMF 108 may include in the DL NAS TRANSPORT message the SOR information received from the UDM 118.

At block 608, the UE 102 performs an SOR information security check. For example, upon receipt of the SOR information, the UE 102 shall perform a security check on the SOR information included in the DL NAS TRANSPORT message to verify that the SOR information is provided by HPLMN 100B. In an instance, the security check is successful and if the SOR information contains a secured packet and the service “data download via SMS Point-to-point” is allocated and activated in the USIM Service Table, the UE 102, or the like (e.g., Mobile Equipment (ME), etc.) shall upload the secured packet to the USIM.

At block 610, the UE 102 generates/causes transmission of an Up Link (UL) NAS Transport message (e.g., based on at least the SOR information security check, or the like). For example, if the UDM 118 has requested an acknowledgement from the UE 102 in the DL NAS TRANSPORT message, the UE 102 causes transmission of an UL NAS TRANSPORT message to the serving AMF with an SOR transparent container including the UE acknowledgement. In some embodiments, the SOR-CMCI may be provided to the UE 102 in a REFRESH command.

At block 612, the AMF 108 generates/causes transmission of an Nudm_SDM Info request message to the UDM 118 (e.g., based on at least the Up Link (UL) NAS Transport message, or the like). For example, if the UL NAS TRANSPORT message with an SOR transparent container is received, the AMF 108 may use the Nudm_SDM Info service operation to provide the received SOR transparent container to the UDM 118. If the HPLMN decided that the UE 102 is to acknowledge successful security check of the received SOR information, the UDM 118 may verify that the acknowledgement is provided by the UE 102. In an instance, the example signal sequence 600 was invoked (e.g., initiated, caused, trigger, etc.) by the HPLMN 100B's associated UDM 118 after receiving from the SOR-AF 119 a new list of preferred PLMN/access technology combinations or a secured packet for the UE 102 identified by SUPI using an Nudm_ParameterProvision_Update request, and the UDM 118 verification of the UE 102 acknowledgement is successful, then the UDM 118 informs the SOR-AF 119 about successful delivery of the list of preferred PLMN/access technology combinations, or of the secured packet to the UE 102, using Nsoraf_SoR_Info comprising the SUPI associated with the UE 102 and/or a successful delivery indication.

At block 614, the UDM 118 generates/causes transmission of an Nsoraf_SoR_Info request to the SOR-AF 119 (e.g., based on at least the Nudm_SDM_Info request message, or the like). For example, the UDM 118 may cause transmission of an Nsoraf_SoR_Info comprising the SUPI associated with the UE 102 and/or a successful delivery indication to the SOR-AF 119. If the HPLMN 100B's policy for the SOR-AF 119 invocation is present and the UDM 118 received and verified the UE 102 acknowledgement, then the UDM 118 informs the SOR-AF 119 about successful delivery of the list of preferred PLMN/access technology combinations, or of the secured packet to the UE 102.

In an instance, the selected PLMN is a VPLMN (e.g., VPLMN 100A, or the like), the UE 102 in manual mode of operation encounters security check failure of SOR information in DL NAS TRANSPORT message, and in response to (e.g., upon detection of, etc.) switching to an automatic network selection mode, the UE 102 remembers (e.g., determines, retrieves a determination/indication, etc.) that the UE 102 is still registered on the PLMN where the security check failure of SOR information was encountered. Further, the UE 102 may wait until it moves to idle mode, or 5GMM-CONNECTED mode with an RRC inactive indication, before attempting to obtain (e.g., retrieve, request, etc.) service on a higher priority PLMN, by acting as if timer T that controls periodic attempts has expired, with an exception that the current registered PLMN is considered as lowest priority. If the selected PLMN is a VPLMN (e.g., VPLMN 100B) and the UE 102 has an established emergency PDU session, then the UE 102 may attempt to perform the PLMN selection after the emergency PDU session is released.

In some embodiments, the receipt of the SOR information by one or more network entities (e.g., UE 102, AMF 108, UDM 118, SOR-AF 119, or other network functions) by itself does not trigger the release of the emergency PDU session. In some embodiments, if the selected PLMN is the HPLMN (e.g., HPLMN 100B), regardless of whether the UE 102 is in an automatic network selection mode, or a manual network selection mode, regardless of whether the UE 102 has an established emergency PDU session or not, and regardless of whether the security check is successful or not successful, the UE 102 is not required to perform the PLMN selection.

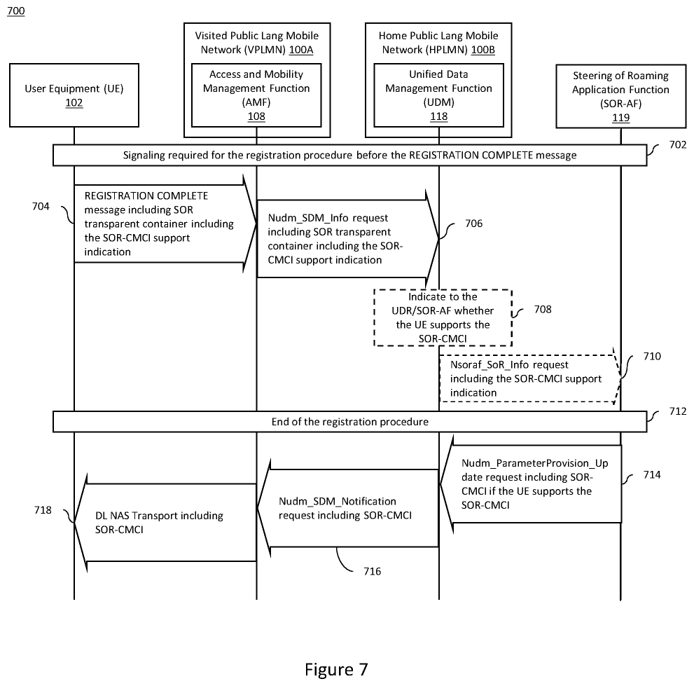

FIG. 7 illustrates a flow chart that depicts an example signal sequence 700, for the provision of timing information indicating a UE's CMCI compatibility/support for controlling of terminal timing within a network, between communication devices. The example signal sequence 700 may be performed, at least sometimes, after a UE has performed at least a portion of example signal sequence 500 and/or example signal sequence 600, for example, to update the UE's CMCI and/or switch to another serving PLMN (e.g., VPLMN, etc.). Example signal sequence 700 is, at least partially, facilitated by way of a network infrastructure (e.g., communications network 100 or the like) and/or one or more communication interfaces (e.g., Communication Interface 206, or the like) of respective apparatuses. As shown, the example network infrastructure utilized for signal sequence 700 comprises at least the UE 102, AMF 108, UDM 118, and SOR-AF of 119. As shown, AMF 108 is associated with a VPLMN 100A and UDM 118 is associated with HPLMN 100B. The VPLMN 100A and the HPLMN 100B may be configured in accordance with one or more configurations of the communications network 100 as described by the present disclosure.

In some embodiments, the network infrastructure utilized with example signal sequence 700 may be configured with the necessary hardware (e.g., base stations, apparatuses for wired/wireless signaling, network function servers, or the like to execute example signal sequence 700) in accordance with 5G system standards, or the like (e.g., 4G, LTE, etc.). For example, the network infrastructure may be configured with one or more of a RAN (not shown), Next Generation Node B (gNB) (not shown) that can comprise one or more 5G radio nodes, such as one or more additional gNBs (not shown) or the like. Additionally, the AMF 108 may be hosted by a computing device (e.g., a server, etc.) associated with the VPLMN 100A and UDM 118 may be hosted by a computing device (e.g., a server, etc.) associated with HPLMN 100B. Moreover, the example signal sequence 700 may be implemented utilizing one or more network infrastructures associated with one or more networks (e.g., a PLMN, an SNPN, PNI-NPN, or the like.) via at least a shared RAN. In some embodiments, timing information comprises one or more of a PLMN-AT list (e.g., a HPLMN's preferred VPLMNs list, a VPLMN priority list, etc.), SOR-CMCI, a determination/indication of whether SOR-CMCI is supported by/compatible with a respective UE or not, or any other SOR information for facilitating VPLMN switching. In some embodiments, the SOR-AF 119 may be hosted by a server associated with one or more networks (e.g., VPLMN 100A, HPLMN 100B, or the like).

The example signal sequence 700 begins at block 702 when the initial signaling required for the registration procedure has been completed, but before the REGISTRATION COMPLETE message has been transmitted by the UE 102. The UE 102 then generates/causes transmission of a REGISTRATION COMPLETE message including at least an SOR transparent container including at least the SOR-CMCI support indication associated with the UE 102 to AMF 108, see block 704. At block 706, the AMF 108 associated with VPLMN 100A generates/causes transmission of, based on at least the REGISTRATION COMPLETE message, an Nudm_SDM Info request message including at least the SOR transparent container including at least the SOR-CMCI support indication associated with the UE 102 to UDM 118. Then UDM 118, in response to receipt of the Nudm_SDM Info request message and based at least thereon, may determine and/or indicate to the UDR 118A whether the UE 102 supports, or is compatible with, the SOR-CMCI, see block 708. At block 710, the UDM 118 may generate/cause transmission of, based on at least the Nudm_SDM Info request message, an Nsoraf_SoR_Info request message including at least the SOR-CMCI support indication associated with UE 102 to an SOR-AF 119. At least the receipt of the Nsoraf_SoR_Info request message, from the UDM 118, by the SOR-AF 119 may cause, or trigger, the end of the registration procedure, see block 712.

At block 714, the SOR-AF 119 generates/causes transmission of an Nudm_ParameterProvision Update request message including at least the SOR-CMCI if the UE 102 is determined to support, or be compatible with, the SOR-CMCI. The SOR-AF 119, or other network function, may determine that the UE 102 supports, or is compatible with, the SOR-CMCI based on at least the SOR transparent container including at least the SOR-CMCI support indication provided by the UE 102. In some embodiments, the determination and/or an indication (e.g., the SOR-CMCI support indication) that the UE 102 does or does not support (is or is not compatible with) SOR-CMCI may be stored via a repository, database, memory device, or the like. For example, the determination and/or an indication (e.g., the SOR-CMCI support indication) that the UE 102 does or does not support (is or is not compatible with) SOR-CMCI may be stored via UDR 118A.

At block 716, the UDM 118 generates/causes transmission of an Nudm_SDM_Notification request message including at least the SOR-CMCI associated with a respective UE (e.g., UE 102). In some embodiments, the Nudm_SDM_Notification request message may be generated based on at least the Nudm_ParameterProvision Update request message received from the SOR-AF 119. At block 718, the AMF 108 may generate/cause transmission of a DL NAS TRANSPORT message including at least SOR-CMCI. In some embodiments, the DL NAS TRANSPORT message may be generated based on at least the Nudm_SDM_Notification request message received from the UDM 118.

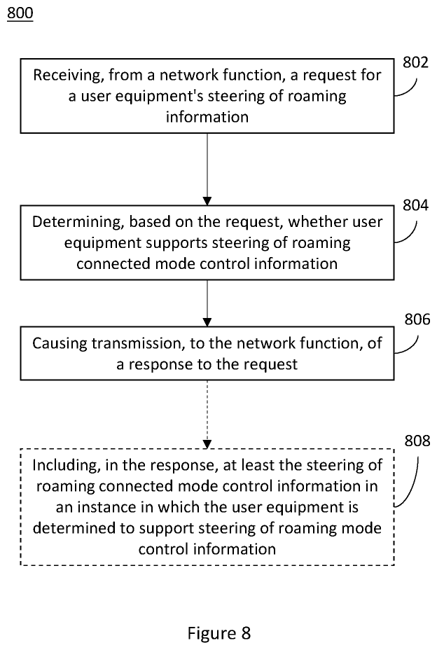

FIG. 8 illustrates a flowchart of the operations of an example method 800 performed by an example apparatus 200 which, in some embodiments, may be embodied by a server (e.g., associated with UDM 118, UDR 118A, SOR-AF 119, etc.), or the like, which, in turn, may include a computer program product comprising a non-transitory computer readable medium (e.g., memory 204) storing computer program code executed by, for example, processor 202. The example method 800 may be at least partially carried out by an example apparatus configured with purpose built circuitry configured with purposed built hardware, software, and/or firmware. The example method 800 may be carried out, at least partially, in the context of one or more flow diagrams illustrating the signaling between network entities as described above with respect to FIGS. 5-7.

As shown in block 802, apparatus 200 of this example embodiment includes means, such as the processor 202, the memory 204, the communication interface 206 or the like, for receiving, from a network function, a request for a user equipment's steering of roaming information. See, for example, block 512 of FIG. 5 which depicts the transmission of an Nsoraf SoR Get request to a network function (e.g., SOR-AF). At block 804, the example apparatus (e.g., a network function hosting server or the like), includes means for determining, based on the request, whether user equipment supports steering of roaming connected mode control information. Additionally, at block 806 the apparatus may be configured with circuitry, or the like, for causing transmission, to the network function, of a response to the request. See, for example, block 514 of FIG. 5 which depicts the transmission of an Nsoraf SoR Get response to a network function (e.g., UDM). In some embodiments, the apparatus may be further configured with means for including, in the response, at least the steering of roaming connected mode control information in an instance in which the user equipment is determined to support steering of roaming mode control information, see block 808. See, for example, block 714 of FIG. 7 which depicts the transmission of an Nudm_ParameterProvision Update request including SOR-CMCI based on an indication that the UE supports the SOR-CMCI. Moreover, for example, the apparatus may generate the response and the steering of roaming connected mode control information or the apparatus may retrieve the steering of roaming connected mode control information from a repository and/or database and generate the response using the retrieved steering of roaming connected mode control information.

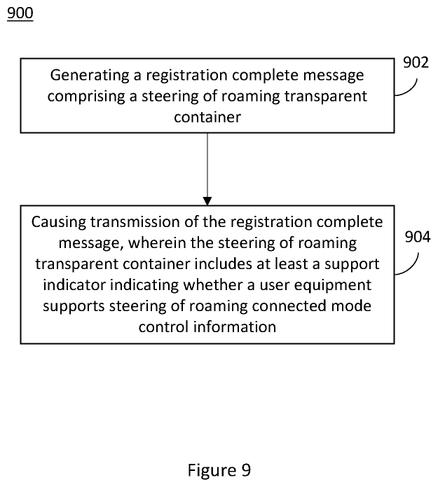

FIG. 9 illustrates a flowchart of the operations of an example method 900 performed by an example apparatus 200 which, in some embodiments, may be embodied by a UE (e.g., a smartphone, laptop, etc.), or the like, which, in turn, may include a computer program product comprising a non-transitory computer readable medium (e.g., memory 204) storing computer program code executed by, for example, processor 202. The example method 900 may be at least partially carried out by an example apparatus configured with purpose built circuitry configured with purposed built hardware, software, and/or firmware. The example method 900 may be carried out, at least partially, in the context of one or more flow diagrams illustrating the signaling between network entities as described above with respect to FIGS. 5-7.

As shown in block 902, apparatus 200 of this example embodiment includes means, such as the processor 202, the memory 204, the communication interface 206 or the like, for generating a registration complete message comprising a steering of roaming transparent container. See, for example, block 704 of FIG. 7 which depicts the generation and transmission of a REGISTRATION COMPLETE message including an SOR transparent container comprising a SOR-CMCI support indication. At block 904, the example apparatus (e.g., a smartphone, personal computing device, or the like), includes means, such as circuitry or the like, for causing transmission of the registration complete message. In some embodiments, the steering of roaming transparent container may be configured (e.g., generated by the apparatus) to include at least a support indicator indicating whether a user equipment supports steering of roaming connected mode control information. See, for example, block 704 of FIG. 7 as described above; additionally, see for example, block 528 of FIG. 5 which illustrates the transmission of a REGISTRATION COMPLETE message that may be configured with an SOR transparent container comprising a SOR-CMCI support indication.

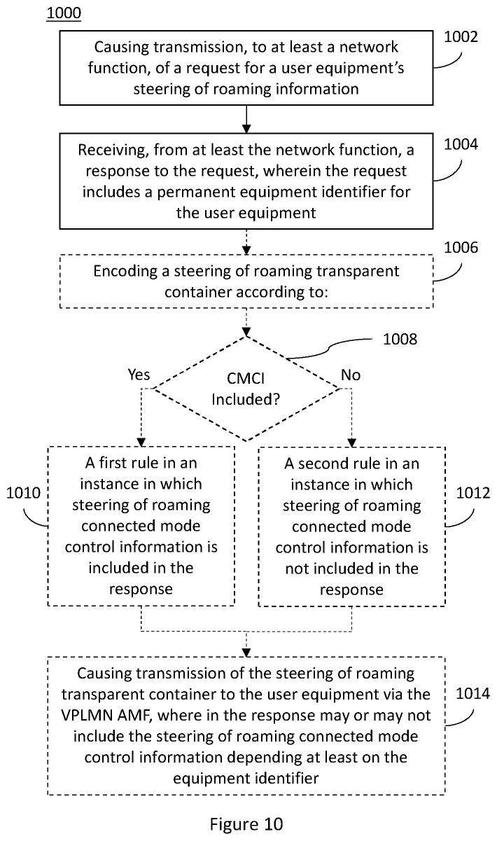

FIG. 10 illustrates a flowchart of the operations of an example method 1000 performed by an example apparatus 200 which, in some embodiments, may be embodied by a server (e.g., associated with UDM 118, UDR 118A, SOR-AF 119, etc.), or the like, which, in turn, may include a computer program product comprising a non-transitory computer readable medium (e.g., memory 204) storing computer program code executed by, for example, processor 202. The example method 1000 may be at least partially carried out by an example apparatus configured with purpose built circuitry configured with purposed built hardware, software, and/or firmware. The example method 1000 may be carried out, at least partially, in the context of one or more flow diagrams illustrating the signaling between network entities as described above with respect to FIGS. 5-7.

As shown in block 1002, apparatus 200 of this example embodiment includes means, such as the processor 202, the memory 204, the communication interface 206 or the like, for causing transmission, to at least a network function, of a request for a user equipment's steering of roaming information. See, for example, block 512 of FIG. 5 which depicts the transmission of an Nsoraf SoR Get request to a network function (e.g., UDR, SOR-AF, of the like). At block 1004, the example apparatus (e.g., a network function hosting server or the like), includes means for receiving, from at least the network function, a response to the request, wherein the request includes a permanent equipment identifier for the user equipment. See, for example, block 514 of FIG. 5 which depicts the receipt of an Nsoraf SoR Get response by a network function (e.g., UDM).

In some embodiments, at block 1006 the apparatus may be further configured with circuitry, or the like, for encoding a steering of roaming transparent container according to one or more trigger conditions, see block 1006. In some embodiments, the trigger condition may include a detection and/or receipt of connected mode control information, such as receiving steering of roaming connected mode control information via the response message. See, for example, block(s) 516 and/or 518 of FIG. 5 which depicts the securing of SOR information and the transmission of an Nudm_SDM_Get response comprising at least an SOR transparent container.

In some embodiments, the apparatus may be further configured with means for detecting the presence of connected mode control information, see block 1008. In an instance, the connected mode control information is detected by the apparatus, the steering of roaming transparent container may be encoded based on at least a first rule in an instance in which steering of roaming connected mode control information is included in the response, see block 1010. See, for example, block(s) 516 and/or 518 of FIG. 5 as described above. In an instance, the connected mode control information is not detected by the apparatus, the steering of roaming transparent container may be encoded based on at least a second rule in an instance in which steering of roaming connected mode control information is not included in the response, see block 1012. See, for example, block(s) 516 and/or 518 of FIG. 5 as described above. In some embodiments, the apparatus may be further configured with means for causing transmission of the steering of roaming transparent container to the user equipment via the VPLMN AMF, where in the response may or may not include the steering of roaming connected mode control information depending at least on the equipment identifier see block 1014. See, for example, block 716 of FIG. 7 and/or block 604 of FIG. 6, which depict the UDM causing transmission of the Nudm_SDM_Notification request including SOR-CMCI to the AMF for further transmission to the UE.

As described above, the referenced flowcharts of methods that can be carried out by an apparatus according to related computer program products comprising computer program code. It will be understood that each block of the flowcharts, and combinations of blocks in the flowcharts, can be implemented by various means, such as hardware, firmware, processor, circuitry, and/or other devices associated with execution of software including one or more computer program instructions. For example, one or more of the procedures described above can be embodied by computer program instructions. In this regard, the computer program instructions which embody the procedures described above can be stored by a memory device, e.g., 204, of an apparatus, e.g., 200, employing an embodiment of the present disclosure and executed by processor, e.g., 202, of the apparatus. As will be appreciated, any such computer program instructions can be loaded onto a computer or other programmable apparatus (e.g., hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture, the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above. In other embodiments, the computer program instructions, such as the computer-readable program code portions, need not be stored or otherwise embodied by a non-transitory computer-readable storage medium, but can, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations, methods, steps, processes, apparatuses, or the like, above can be modified or further amplified. Furthermore, in some embodiments, additional optional operations, methods, steps, processes, hardware, or the like, can be included. Modifications, additions, subtractions, inversions, correlations, proportional relationships, disproportional relationships, attenuation and/or amplifications to the operations above can be performed in any order and in any combination. It will also be appreciated that in instances where particular operations, methods, processes, or the like, required particular hardware such hardware may be considered as part of apparatus 200 for any such embodiment.

Many modifications and other embodiments of the present disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims.

Example embodiments of the present disclosure are described in the following.

### Example 1

An apparatus comprising:

at least one processor; and

at least one memory including computer program code,

the at least one memory and the computer program code configured to, with the at least one processor, cause the apparatus at least to:

receive, from a network function, a request for a user equipment's steering of roaming information;

determine, based on the request, whether user equipment supports steering of roaming connected mode control information; and

cause transmission, to the network function, of a response to the request.

### Example 2

The apparatus according to Example 1, wherein the at least one memory and the computer program code are further configured to, with the at least one processor, cause the apparatus to:

include, in the response, at least the steering of roaming connected mode control information in an instance in which the user equipment is determined to support steering of roaming mode control information.

### Example 3

The apparatus according to any of Examples 1 and 2, wherein the request comprises a permanent equipment identifier for the user equipment.

### Example 4

The apparatus according to any of Examples 1 to 3, wherein the response is associated with the user equipment.

### Example 5

The apparatus according to any of Examples 1 to 4, wherein the network function comprises a unified data management.

### Example 6

A computer program product comprising a non-transitory computer readable storage medium having program code portions stored thereon, the program code portions configured, upon execution, to:

receive, from a network function, a request for a user equipment's steering of roaming information;

determine, based on the request, whether user equipment supports steering of roaming connected mode control information; and

cause transmission, to the network function, of a response to the request.

### Example 7

The computer program product according to Example 6, further comprising:

include, in the response, at least the steering of roaming connected mode control information in an instance in which the user equipment is determined to support steering of roaming mode control information.

### Example 8

The computer program product according to any of Examples 6 and 7, wherein the request comprises a permanent equipment identifier for the user equipment.

### Example 9

The computer program product according to any of Examples 6 to 8, wherein the response is associated with the user equipment.

### Example 10

The computer program product according to any of Examples 6 to 9, wherein the network function comprises a unified data management.

### Example 11

A method comprising:

receiving, from a network function, a request for a user equipment's steering of roaming information;

determining, based on the request, whether user equipment supports steering of roaming connected mode control information; and

causing transmission, to the network function, of a response to the request.

### Example 12

The method according to Example 11, further comprising:

including, in the response, at least the steering of roaming connected mode control information in an instance in which the user equipment is determined to support steering of roaming mode control information.

### Example 13

The method according to any of Examples 11 and 12, wherein the request comprises a permanent equipment identifier for the user equipment.

### Example 14

The method according to any of Examples 11 to 13, wherein the response is associated with the user equipment.

### Example 15

The method according to any of Examples 11 to 14, wherein the network function comprises a unified data management.

### Example 16

A apparatus comprising:

means for receiving, from a network function, a request for a user equipment's steering of roaming information;

means for determining, based on the request, whether user equipment supports steering of roaming connected mode control information; and

means for causing transmission, to the network function, of a response to the request.

### Example 17

The apparatus according to Example 16, further comprising:

means for including, in the response, at least the steering of roaming connected mode control information in an instance in which the user equipment is determined to support steering of roaming mode control information.

### Example 18

The apparatus according to any of Examples 16 and 17, wherein the request comprises a permanent equipment identifier for the user equipment.

### Example 19

The apparatus according to any of Examples 16 to 18, wherein the response is associated with the user equipment.

### Example 20

The apparatus according to any of Examples 16 to 19, wherein the network function comprises a unified data management.

### Example 21

An apparatus comprising:

at least one processor; and

at least one memory including computer program code,

the at least one memory and the computer program code configured to, with the at least one processor, cause the apparatus at least to:

cause transmission, to at least a network function, of a request for a user equipment's steering of roaming information; and

receive, from at least the network function, a response to the request,

wherein the request includes a permanent equipment identifier for the user equipment.

### Example 22

The apparatus according to Example 21, further comprising:

encode a steering of roaming transparent container according to:
a first rule in an instance in which steering of roaming connected mode control information is included in the response; or
a second rule in an instance in which steering of roaming connected mode control information is not included in the response; and

cause transmission of the steering of roaming transparent container to the user equipment,

wherein the response may or may not include the steering of roaming connected mode control information depending at least on the equipment identifier.

### Example 23

The apparatus according to any of Examples 21 and 22, wherein the network function comprises one or more of a unified data repository or a steering of roaming application function.

### Example 24

Example 1: A computer program product comprising a non-transitory computer readable storage medium having program code portions stored thereon, the program code portions configured, upon execution, to:

cause transmission, to at least a network function, of a request for a user equipment's steering of roaming information; and

receive, from at least the network function, a response to the request,

wherein the request includes a permanent equipment identifier for the user equipment.

### Example 25

The computer program product according to Example 24, further comprising:

encode a steering of roaming transparent container according to:
a first rule in an instance in which steering of roaming connected mode control information is included in the response; or
a second rule in an instance in which steering of roaming connected mode control information is not included in the response; and

cause transmission of the steering of roaming transparent container to the user equipment,

wherein the response may or may not include the steering of roaming connected mode control information depending at least on the equipment identifier.

### Example 26

The computer program product according to any of Examples 24 and 25, wherein the network function comprises one or more of a unified data repository or a steering of roaming application function.

### Example 27

A method comprising:

causing transmission, to at least a network function, of a request for a user equipment's steering of roaming information; and

receiving, from at least the network function, a response to the request,

wherein the request includes a permanent equipment identifier for the user equipment.

### Example 28

The method according to Example 27, further comprising:

encoding a steering of roaming transparent container according to:
a first rule in an instance in which steering of roaming connected mode control information is included in the response; or
a second rule in an instance in which steering of roaming connected mode control information is not included in the response; and

causing transmission of the steering of roaming transparent container to the user equipment,

wherein the response may or may not include the steering of roaming connected mode control information depending at least on the equipment identifier.

### Example 29

The method according to any of Examples 27 and 28, wherein the network function comprises one or more of a unified data repository or a steering of roaming application function.

### Example 30

A apparatus comprising:

means for causing transmission, to at least a network function, of a request for a user equipment's steering of roaming information; and

means for receiving, from at least the network function, a response to the request,

wherein the request includes a permanent equipment identifier for the user equipment.

### Example 31

The apparatus according to Example 30, further comprising:

means for encoding a steering of roaming transparent container according to:
a first rule in an instance in which steering of roaming connected mode control information is included in the response; or
a second rule in an instance in which steering of roaming connected mode control information is not included in the response; and

means for causing transmission of the steering of roaming transparent container to the user equipment,

wherein the response may or may not include the steering of roaming connected mode control information depending at least on the equipment identifier.

### Example 32

The apparatus according to any of Examples 30 and 31, wherein the network function comprises one or more of a unified data repository or a steering of roaming application function.

### Example 33

An apparatus comprising:

at least one processor; and

at least one memory including computer program code,

the at least one memory and the computer program code configured to, with the at least one processor, cause the apparatus at least to:

generate a registration complete message comprising a steering of roaming transparent container; and

cause transmission of the registration complete message,

wherein the steering of roaming transparent container includes at least a support indicator indicating whether a user equipment supports steering of roaming connected mode control information.

### Example 34

The apparatus according to Example 33, wherein the support indicator is included in a steering of roaming header of the steering of roaming transparent container.

### Example 35

The apparatus according to any of Examples 33 and 34, wherein the support indicator comprises a single bit of information.

### Example 36

A computer program product comprising a non-transitory computer readable storage medium having program code portions stored thereon, the program code portions configured, upon execution, to:

generate a registration complete message comprising a steering of roaming transparent container; and

cause transmission of the registration complete message,

wherein the steering of roaming transparent container includes at least a support indicator indicating whether a user equipment supports steering of roaming connected mode control information.

### Example 37

The computer program product according to Example 36, wherein the support indicator is included in a steering of roaming header of the steering of roaming transparent container.

### Example 38

The computer program product according to any of Examples 36 and 37, wherein the support indicator comprises a single bit of information.

### Example 39

A method comprising:

generating a registration complete message comprising a steering of roaming transparent container; and

causing transmission of the registration complete message,

wherein the steering of roaming transparent container includes at least a support indicator indicating whether a user equipment supports steering of roaming connected mode control information.

### Example 40

The method according to Example 39, wherein the support indicator is included in a steering of roaming header of the steering of roaming transparent container.

### Example 41

The method according to any of Examples 39 and 40, wherein the support indicator comprises a single bit of information.

### Example 42

A apparatus comprising:

means for generating a registration complete message comprising a steering of roaming transparent container; and

means for causing transmission of the registration complete message,

wherein the steering of roaming transparent container includes at least a support indicator indicating whether a user equipment supports steering of roaming connected mode control information.

### Example 43

The apparatus according to Example 42, wherein the support indicator is included in a steering of roaming header of the steering of roaming transparent container.

### Example 44

The apparatus according to any of Examples 42 and 43, wherein the support indicator comprises a single bit of information.

Moreover, although the foregoing descriptions and the associated drawings describe certain example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1. An apparatus comprising:
at least one processor; and
at least one memory including computer program code,
the at least one memory and the computer program code configured to, with the at least one processor, cause the apparatus at least to:
generate a registration complete message comprising a steering of roaming transparent container; and
cause transmission of the registration complete message,
wherein the steering of roaming transparent container includes at least a support indicator indicating whether a user equipment supports steering of roaming connected mode control information.

2. The apparatus according to claim 1, wherein the support indicator is included in a steering of roaming header of the steering of roaming transparent container.

3. The apparatus according to claim 1, wherein the support indicator comprises a single bit of information.

4. The apparatus according to claim 1, wherein the user equipment comprises mobile equipment.

5. A method comprising:
generating a registration complete message comprising a steering of roaming transparent container; and
causing transmission of the registration complete message,
wherein the steering of roaming transparent container includes at least a support indicator indicating whether a user equipment supports steering of roaming connected mode control information.

6. The method according to claim 5, wherein the support indicator is included in a steering of roaming header of the steering of roaming transparent container.

7. The method according to claim 5, wherein the support indicator comprises a single bit of information.

8. An apparatus comprising:
at least one processor; and
at least one memory including computer program code,
the at least one memory and the computer program code configured to, with the at least one processor, cause the apparatus at least to:
receive, from a network function, a request for a user equipment's steering of roaming information;
determine, based on the request, whether user equipment supports steering of roaming connected mode control information; and
cause transmission, to the network function, of a response to the request.

9. The apparatus according to claim 8, wherein the at least one memory and the computer program code are further configured to, with the at least one processor, cause the apparatus to:
include, in the response, at least the steering of roaming connected mode control information in an instance in which the user equipment is determined to support steering of roaming mode control information.

10. The apparatus according to claim 8, wherein the request comprises at least one of an identifier associated with a visited public land mobile network, VPLMN, a Subscription Permanent Identifier, SUFI, associated with the user equipment , an access type, an access type parameter, or a permanent equipment identifier for the user equipment.

11. The apparatus according to claim 8, wherein the response is associated with the user equipment.

12. The apparatus according to claim 8, wherein the network function comprises a unified data management.

13. A method comprising:
receiving, from a network function, a request for a user equipment's steering of roaming information;
determining, based on the request, whether user equipment supports steering of roaming connected mode control information; and
causing transmission, to the network function, of a response to the request.

14. The method according to claim 13, further comprising:
including, in the response, at least the steering of roaming connected mode control information in an instance in which the user equipment is determined to support steering of roaming mode control information.

15. The method according to claim 13, wherein the network function comprises a unified data management.

16. An apparatus comprising:
at least one processor; and
at least one memory including computer program code,
the at least one memory and the computer program code configured to, with the at least one processor, cause the apparatus at least to:
cause transmission, to at least a network function, of a request for a user equipment's steering of roaming information; and
receive, from at least the network function, a response to the request,
wherein the request includes at least one of an identifier associated with a visited public land mobile network, VPLMN, a Subscription Permanent Identifier, SUFI, associated with the user equipment, an access type, an access type parameter, or a permanent equipment identifier for the user equipment.

17. The apparatus according to claim 16, wherein the at least one memory and the computer program code are further configured to, with the at least one processor, cause the apparatus at least to:
receive a steering of roaming connected mode control information transparent container
including a support indication indicating whether a user equipment supports
steering of roaming connected mode control information; and
cause transmission of steering of roaming connected mode control information in response to receiving the support indication.

18. The apparatus according to claim 16, wherein the at least one memory and the computer program code are further configured to, with the at least one processor, cause the apparatus at least to:
encode a steering of roaming transparent container according to:
a first rule in an instance in which steering of roaming connected mode control information is included in the response; or
a second rule in an instance in which steering of roaming connected mode control information is not included in the response; and
cause transmission of the steering of roaming transparent container to the user equipment,
wherein the response may or may not include the steering of roaming connected mode control information depending at least on the equipment identifier.

19. The apparatus according to claim 16, wherein the network function comprises one or more of a unified data repository or a steering of roaming application function.

20. A method comprising:
causing transmission, to at least a network function, of a request for a user equipment's steering of roaming information; and
receiving, from at least the network function, a response to the request,
wherein the request includes at least one of an identifier associated with a visited public land mobile network, VPLMN, a Subscription Permanent Identifier, SUFI, associated with the user equipment, an access type, an access type parameter, or a permanent equipment identifier for the user equipment.

21. The method according to claim 20, wherein the network function comprises one or more of a unified data repository or a steering of roaming application function.
